(19) United States
(12) Patent Application Publication
(10) Pub. No.: US 2009/0208271 A1
(43) Pub. Date: Aug. 20, 2009

(54) MODULAR COUPLING SYSTEM

(76) Inventor: Kenneth P. Krohn, Oceanside, CA (US)

Correspondence Address: LAW OFFICE OF KENNETH P. KROHN,;A PROFESSIONAL LAW CORPORATION, POST OFFICE BOX 4415, CARLSBAD, CA, 92018, US

(21) Appl. No.: 12/371,780

(22) Filed: Feb. 16, 2009

Related U.S. Application Data
(60) Provisional application No. 61/066,258, filed on Feb. 19, 2008.

(51) Int. Cl. F16L 25/06

(52) U.S. Cl. 403/4

(57) ABSTRACT

The present invention generally relates to a modular coupling system, which may comprise one or more casing members and one or more modular connectors. The casing members are adapted to be connected to the modular connectors of the system and may take the form of almost any type of fitting or connecting device (such as a tee, elbow, valve, coupling, container, machinery or equipment). The modular connectors are adapted to be connected to the casing members of the system and also to one or more ducts (such as pipes or tubing that may have threaded, slip, quick-connect, or other connecting means). Thus, the system allows the use of multiple modular connectors (which may each be adapted to connect to a different type of duct) to be used interchangeably with multiple types of casing members. The invention also includes certain kits and methods of using the system.

### CROSS REFERENCES TO OTHER APPLICATIONS

This application claims the benefit of U.S. provisional application No. 61/066,258, filed on Feb. 19, 2008, which is incorporated herein by reference.

### BACKGROUND

The present invention generally relates to modularized systems that may be used to permanently or removably connect to a duct (such as a length of pipe or tubing or a container or fitting), as well as kits and methods of use related to the systems. For example, in one embodiment, the systems may comprise a casing member and interchangeable modular connectors that may be used with the casing member. The various modular connectors are adapted to be connected to different types and sizes of ducts.

Apparatus currently exist in the relevant art that are used to connect lengths of pipe and tubing together. For example, copper pipelines often utilize copper fittings, such as standard couplings, tees and elbows, to connect lengths of copper pipe together. Typically, neither the lengths of pipe nor the fittings have threads. Instead, the fittings have openings therein that are designed so that the entire circumference around the end portion of the pipe is held snuggly against the interior surfaces of the opening in the fitting. The end of the pipe is inserted into the opening in the fitting, and a flux/solder (such as lead-based solder) combination or solder (such as silver solder) is used to create a fluid-tight seal between the fitting and the length of pipe. Plastic pipelines, such as those constructed of polyvinyl chloride (PVC), often utilize plastic fittings that are not threaded and function in a manner similar to the copper fittings. In these cases, the end of the length of plastic pipe is inserted into the opening in the fitting, and the pipe is held snuggly against the interior surfaces of the opening in the fitting. A fluid-tight seal is created by using a primer/glue combination on the interfacing surfaces of the pipe and fitting. These types of fittings are sometimes referred to as “slip” fittings. Some pipelines, such as those constructed of steel, brass, and sometimes plastic, typically utilize fittings, such as couplings, tees and elbows, in which the lengths of pipe have a threaded end and the fittings have a corresponding threaded opening. In these cases, the threaded ends of the pipes are screwed into the threaded openings in the fittings. The fluid-tight seal between the end of the length of pipe and the fitting may be created by the fit of the threads themselves, or by use of a sealing compound in conjunction with the threads.

As yet another example, some coupling devices utilize a compression-type means. In these devices, a gasket, ferrule or ring (typically of rubber, plastic or metal) may be positioned on a portion of the length of pipe at or near the end thereof. The end of the pipe is inserted into the coupling, and the coupling has a means to compress the gasket or ring against the end or outside surface of the pipe to form a fluid-tight seal and to hold the pipe in position relative to the coupling device. Yet other types of compression connectors may be comprised of variable connecting means designed for use with different sizes and shapes of ducts (such as pipes and tubing). Thus, a single compression connector having variable connecting means may be used to connect to a standard garden hose, a ¾″ nominal diameter steel pipe having NPT threads, or a 1″ Type L copper pipe. Examples of these types of compression connectors are disclosed in U.S. Nonprovisional patent application Ser. No. 11/522,607 filed on Sep. 18, 2006, Ser. No. 11/879,346 filed on Jul. 17, 2007, Ser. No. 12/012,954 entitled DUCT COUPLING ADJUSTMENT AND THRUST LOAD RESTRAINT SYSTEM, filed on Feb. 6, 2008, and U.S. Provisional Patent Application No. 61/062,428 filed on Jan. 25, 2008, which also name as inventor the inventor of the present invention. The entire disclosure of each of these patent applications is incorporated herein by this reference. Still other devices may utilize grooves that are cut into the outside surface of the length of pipe. Corresponding fittings fit into these grooves to form a fluid-tight seal and hold the pipe in position relative to the coupling device.

In each of the coupling devices described above, however, the fittings are generally designed to be used with ducts having limited characteristics. For example, a ¾″ black steel tee having NPT threaded openings can only be used with ¾″ nominal diameter pipe having NPT threads on the end of the pipe to be connected to the tee. This tee cannot be directly used with 1″ Type L copper pipe. Nor can the tee be used with a standard garden hose because the NPT threads on the end of the pipe do not match the threads on the open end of the garden hose. As another example, a ½″ copper coupling can only be used with ½″ nominal diameter copper pipe. The coupling cannot be directly used with ½″ PVC pipe.

There are, however, instances where it may be desirable to connect a coupling device to more than one duct (such as a length of pipe or tubing) having multiple sizes, thread types, or compositions (such as steel, plastic or copper), but a single conventional coupling device is not available to make the desired connection. For example, a person may desire to connect a standard garden hose to a ¾″ PVC pipe, but a conventional adapting connector is not available. In such cases, the means to make the connection may be inconvenient, difficult, or sometimes even impossible to obtain under the circumstances. Even where the coupling device includes variable connecting means, there may be cases where it is desirable to use a single device or system to connect to ducts that have a great enough difference in size or shape that one version of variable connecting means alone is not sufficient to make the connection. For example, a coupling with variable connecting means designed for pipes having an outside diameter of 0.84″ to 1.05″ will not, without more, accommodate a connection to a pipe having an outside diameter of 0.5″. Thus, there is a need for a single device or system that may be used to connect to ducts, such as an item of equipment, a tank or container, or a length of pipe or tubing, having a variety of different sizes and characteristics (such as thread type and style). This device or system may utilize a variety of different types of conventional connecting devices (such as the fittings described above) to make a fluid-tight connection to a variety of different types and sizes of ducts. In addition, a device or system of this type may reduce the expense required to make such connections because only one device or system, as opposed to a combination of conventional coupling devices, is necessary to make the connection. Further, because of the flexibility in use of the device or system, it may be possible to reduce the number of fittings that need to be maintained in inventory because one device or system may be used for a number of different connection types that would otherwise require multiple conventional coupling devices. For example, a plumber may need to carry fewer overall components of the system of the present invention on his or her service vehicle, as opposed to a multitude of different types of conventional coupling devices. Further still, when incorporated as part of an item of equipment, the device or system may enable a multitude of different sizes and types of ducts to be connected to the item of equipment, as opposed to a conventional coupling device that requires use of a specific type and size of duct. Thus, an item of equipment intended for distribution to countries using metric sizes of ducts, as well as countries using ducts having English units of measurement, would require only a single variable joining device or system, as opposed to multiple conventional coupling devices.

### SUMMARY

The present invention is directed to a device and system, as well as related kits and methods of using the device and system, which meet the needs discussed above in the Background section. As described in greater detail below, the present invention, when used for its intended purposes, has many advantages over other devices known in the art, as well as novel features that result in a new device, kits and methods of using the device that are not anticipated, rendered obvious, suggested, or even implied by any prior art devices or methods, either alone or in any combination thereof.

In a preferred embodiment of the present invention, a device is disclosed that is comprised of a casing member and at least one first modular connector. The casing member is further comprised of modular connecting means adapted for connecting the casing member to the at least one first modular connector. The at least one first modular connector further comprises modular connecting means for connecting the at least one first modular connector to the casing member and duct connecting means for connecting the at least one first modular connector to at least one duct. Both of these means are described in more detail below. The modular connecting means of the casing member are also adapted to be connected to at least one second modular connector that also comprises modular connecting means. Thus, the at least one first modular connector is interchangeable with the at least one second modular connector in its operation with the casing member. In another embodiment, the casing member is comprised of a case body, a case cap, and case cap connecting means, which are described in more detail below. The case body has a casing interior space and at least one case body open end adjoining the casing interior space. The case cap has a connector opening, and the duct connecting means are adapted to be positioned approximately within the connector opening. The case cap connecting means removably or permanently connect the case cap to the case body at the case body open end, as described in more detail below. In these embodiments, the at least one first modular connector and the at least one second modular connector are adapted to be separately positioned approximately within the case body opening while the case cap is connected to the case body. In some of these embodiments, the case cap connecting means are comprised of a threaded portion on the case body adjacent to the at least one case body open end and a threaded portion on an opening of the case cap, so that the case cap is adapted to be screwed down onto the case body. Generally, a method of using the device comprises selecting the casing member and then connecting the at least one first modular connector to the casing member using the modular connecting means. The present invention also includes a kit comprising the casing member and the at least one first modular connector, as well as a kit comprising the at least one first modular connector and the at least one second modular connector.

Referring to these embodiments as an example, the casing member may be in the shape of a coupling, so that it is adapted to be connected to two ducts simultaneously. (In other embodiments, the casing member may be in the form of almost any type of fitting, such as a tee, elbow, union, or valve.) In this embodiment, the case body of the coupling may have a threaded connection at each end thereof, which corresponds to a threaded portion of a case cap that is positioned at one end of, and screwed down onto, the end of the case body. Each of the modular connectors is shaped so that it fits into the opening of the case body, typically between the case body and the case cap. As the case cap is screwed down onto the case body, the modular connecting means is comprised of the modular connector being held in place between case cap and the case body by the threaded connection and appropriate means to form a fluid-tight seal. Each of the modular connectors is also adapted to be connected to at least one duct. For example, modular connectors may have MIP, FIP, slip, compression, variable connecting means, or almost any other type of connecting means currently known in the relevant art or that may be developed in the relevant art in the future. Thus, if the user of the system desires to connect a ¾″ MIP galvanized steel pipe having NPT threads to an unthreaded 1″ MIP PVC (polyvinyl chloride) pipe, the user may select the coupling, unscrew the case cap from one end, place a modular connector having a ¾″ FIP adapter in the open end, and then screw the cap down onto the end until the modular connector is sealed between them. The user may then unscrew the case cap from the other end of the coupling, place a modular connector having a 1″ FIP slip adapter in the open end, and then screw the cap down onto the end until the modular connector is sealed between them. The coupling may then be connected to each of the ducts. Alternatively, the modular connectors may be connected to the ducts, and may then be connected to the coupling case body using the modular connecting means. It is to be noted that other embodiments of the present invention are described in more detail below.

Therefore, the modular coupling system of the present invention meets the requirements described above in the Background section. The user of the system need only purchase basic forms of casing members that he or she anticipates using. For example, the user may purchase a variety of couplings, tees, elbows, unions and valves. The user may then also purchase the types of modular connectors that he or she anticipates using. For example, the user may purchase a variety of modular connectors having ½, ¾″ and 1″ slip, MIP and FIP adapters, as well as modular connectors comprising variable connecting means. Each of these modular connectors may be used in conjunction with each of the couplings, tees, elbows, unions and valves in any combination desired by the user. Thus, the user has the flexibility of selecting any of the casing members and using any of the modular connectors with the selected casing member in order to connect a variety of different ducts to the devices comprising the system of the present invention. If the user is not sure what types of connectors he or she will need to complete a project, the user need only purchase the basic casing member and the variety of possible modular connectors that will or may be needed. If a particular modular connector is not needed for the current project, it may be used with any casing member for a future project. The user is not required to purchase a variety of conventional fittings, some of which may not be needed for the current project and which may never be used in the future. This should eliminate waste and reduce expenses. In addition, the device of the present invention may eliminate multiple trips to the supplier to purchase required fittings to complete a duct-connecting project.

There has thus been outlined, rather broadly, the more primary features of an embodiment of the present invention. There are additional features that are also included in the various embodiments of the invention that are described hereinafter and that form the subject matter of the claims appended hereto. In this respect, it is to be understood that the invention is not limited in its application to the details of construction and to the arrangements of the components set forth in the following description or illustrated in the following drawings. This invention may be embodied in the form illustrated in the accompanying drawings, but the drawings are illustrative only and changes may be made in the specific construction illustrated and described within the scope of the appended claims. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

The foregoing summary, as well as the following description, will be better understood when read in conjunction with the appended drawings, in which:

FIG. 1A is a perspective view of an embodiment of a device of the present invention, as viewed from the side of and above one end of the device, the device generally comprising a coupling.

FIG. 1B is a perspective view of the device illustrated in FIG. 1A, as viewed from the side of and above the other end of the device.

FIG. 1C is a partially exploded perspective view of the device illustrated in FIG. 1A and FIG. 1B, as viewed from the side of and above the same end of the device as is illustrated in FIG. 1B.

FIG. 2 is an exploded perspective view of an embodiment of a variable connecting member, which is a part of the device illustrated in FIG. 1A through FIG. 1C, as viewed from the side of and above the variable connecting member.

FIG. 3 is an exploded perspective view of another embodiment of a variable connecting member, which is a part of the device illustrated in FIG. 1A through FIG. 1C, as viewed from the side of and above the variable connecting member.

FIG. 4 is a perspective view of an embodiment of an internal support member, which is a part of the embodiment of the variable connecting member illustrated in FIG. 2, as viewed from the side of and above the internal support flange member of the internal support member

FIG. 5A is a perspective view of an embodiment of an internal seal member, which is a part of the embodiment of the variable connecting member illustrated in FIG. 2, as viewed from the side of and above the internal seal outlet of the internal seal member.

FIG. 5B is a perspective view of another embodiment of an internal seal member, as viewed from the side of and above the internal seal outlet of the internal seal member.

FIG. 6 is a perspective view of an embodiment of an external seal member, which is a part of the embodiment of the variable connecting member illustrated in FIG. 2, as viewed from the side of and above the external seal outlet of the external seal member.

FIG. 7A is a plan view of an embodiment of an external support structure, which is a part of the embodiment of the variable connecting member illustrated in FIG. 2, as viewed from above the external support flange member of the external support structure.

FIG. 7B is a perspective view of the embodiment of the external support structure illustrated in FIG. 7A, as viewed from the side of and above the distal end of the external support structure, which is the end opposite of that illustrated in FIG. 7A.

FIG. 7C is a perspective view of the embodiment of the external support structure illustrated in FIG. 7A and FIG. 7B, as viewed from the side of and above the external support flange member of the external support structure.

FIG. 8A is a perspective view of an embodiment of the variable connector adjusting member, which is a part of the embodiment of the variable connecting member illustrated in FIG. 3, showing hidden lines in phantom as viewed from above the connector adjusting flange member of the variable connector adjusting member.

FIG. 8B is a perspective view of another embodiment of the variable connector adjusting member, as viewed from above the distal end of the connector adjusting shell portion of the variable connector adjusting member.

FIG. 8C is an exploded perspective view of another embodiment of a casing member and another embodiment of a variable connector adjusting member, as viewed from above and to the side of one end of the casing member and from above the connector adjusting flange member of the variable connector adjusting member.

FIG. 8D is an exploded perspective view of another embodiment of a casing member and another embodiment of a modular connector, as viewed from above and to the side of one end of the casing member and from above the connector flange portion of the modular connector.

FIG. 9A is a plan view of the embodiment of the device illustrated in FIG. 1 through FIG. 3, as viewed from above the end of the device illustrated in FIG. 1A.

FIG. 9B is a sectional view of the embodiment of the device illustrated in FIG. 9A, as taken along the lines 9B-9B in FIG. 9A.

FIG. 10A is an exploded perspective view of another device of the present invention, which comprises another embodiment of a casing member (generally comprising a union), a modular connector comprising variable connecting means, and another embodiment of a modular connector (generally comprising an MIP adapter as duct connecting means), as viewed from above one end and to one side of the device.

FIG. 10B is a perspective view of the MIP modular connector illustrated in FIG. 10A, as viewed from above and to one side of the duct connecting means of the modular connector, and illustrating hidden lines in phantom.

FIG. 11 is a perspective view of another embodiment of a modular connector (comprising a slip adapter as duct connecting means), as viewed from above and to one side of the duct connecting means of the modular connector.

FIG. 12A is an exploded perspective view of another device of the present invention, which comprises another embodiment of a casing member (generally comprising a valve) and other embodiments of a modular connector (generally comprising an FIP adapter, in one case, and an adapting tee, in the other case, as duct connecting means), as viewed from above one end and to one side of the device.

FIG. 12B is a perspective view of the adapting tee modular connector illustrated in FIG. 12A, as viewed from above and to one side of the duct connecting means of the modular connector.

FIG. 12C is a perspective view of the adapting tee modular connector illustrated in FIG. 12A and FIG. 12B, as viewed from above and to one side of the distal end of the connector shell portion of the modular connector.

FIG. 13A is a perspective view of another device of the present invention, which comprises other embodiments of a casing member (generally comprising a tee, in one case, and an elbow, in the other case) and another embodiment of a modular connector (generally comprising a casing connector), as viewed from above and to one side of the device.

FIG. 13B is a perspective view of the casing connector modular connector illustrated in FIG. 13A, as viewed from above one end and to one side of the modular connector.

FIG. 13C is an elevation view of the casing connector modular connector illustrated in FIG. 13A and FIG. 13B, as viewed from the side of the casing connector modular connector.

FIG. 14A is an exploded perspective view of another device of the present invention, which comprises other embodiments of a casing member (generally comprising object connection fittings that are a part of a first modular system, in one case, and a coupling that is a part of a second modular system, in the other case) and another embodiment of a modular connector (generally comprising an adjusting casing connector), as viewed from above and to one side of the device.

FIG. 14B is a perspective view of the adjusting casing connector modular connector illustrated in FIG. 14A, together with two case caps, as viewed from above one end and to one side of the modular connector.

FIG. 15A is an exploded perspective view of another device of the present invention, which comprises another embodiment of a casing member (generally comprising a coupling as a part of a first modular system) and another embodiment of a modular connector (generally comprising an MIP adapter as duct connecting means), as viewed from above one end and to one side of the device.

FIG. 15B is a perspective view of the MIP modular connector illustrated in FIG. 15A, as viewed from above and to one side of the duct connecting means of the modular connector, and illustrating hidden lines in phantom.

FIG. 15C is an exploded perspective view of another device of the present invention, which comprises another embodiment of a casing member (generally comprising a coupling as a part of a second modular system, which is different from that illustrated in FIG. 15A) and an embodiment of a modular connector adjusting member, as viewed from above one end and to one side of the device.

FIG. 15D is a perspective view of the body portion of the modular connector adjusting member illustrated in FIG. 15C, as viewed from above one end and to one side of the modular connector adjusting member body portion.

FIG. 15E is a perspective view of the compression plate portion of the modular connector adjusting member illustrated in FIG. 15C, as viewed from above one end and to one side of the modular connector adjusting member compression plate portion.

FIG. 16 is an exploded perspective view of another device of the present invention, which comprises a casing member, other embodiments of modular connectors (generally comprising an FIP adapter, in one case, and an MIP adapter, in the other case, as duct connecting means), and another embodiment of modular connecting means (generally comprising a compression-type system), as viewed from above one end and to one side of the device.

FIG. 17A is an exploded perspective view of another device of the present invention, which comprises a casing member, another embodiment of a modular connector (generally comprising a slip adapter as duct connecting means), and another embodiment of modular connecting means, as viewed from above one end and to one side of the device.

FIG. 17B is a plan view of the embodiment of the device illustrated in FIG. 17A, as viewed from above the end of the device illustrated in FIG. 17A.

FIG. 17C is a sectional view of the embodiment of the device illustrated in FIG. 17A and FIG. 17B, as taken along the lines 17C-17C in FIG. 17B.

FIG. 18A is an exploded perspective view of another device of the present invention, which comprises a casing member, another embodiment of modular connectors (generally comprising an FIP adapter, in one case, and an MIP adapter, in the other case, as duct connecting means), and another embodiment of modular connecting means, as viewed from above one end and to one side of the device.

FIG. 18B is a plan view of the embodiment of the device illustrated in FIG. 18A, as viewed from above the end of the device illustrated in FIG. 18A.

FIG. 18C is a sectional view of the embodiment of the device illustrated in FIG. 18A and FIG. 18B, as taken along the lines 18C-18C in FIG. 18B.

### DETAILED DESCRIPTION

Reference will now be made in detail to the preferred aspects, versions and embodiments of the present invention, examples of which are illustrated in the accompanying drawings. While the invention will be described in conjunction with the preferred aspects, versions and embodiments, it is to be noted that the aspects, versions and embodiments are not intended to limit the invention to those aspects, versions and embodiments. On the contrary, the invention is intended to cover alternatives, modifications, portions and equivalents, which may be included within the spirit and scope of the invention as defined by the appended claims.

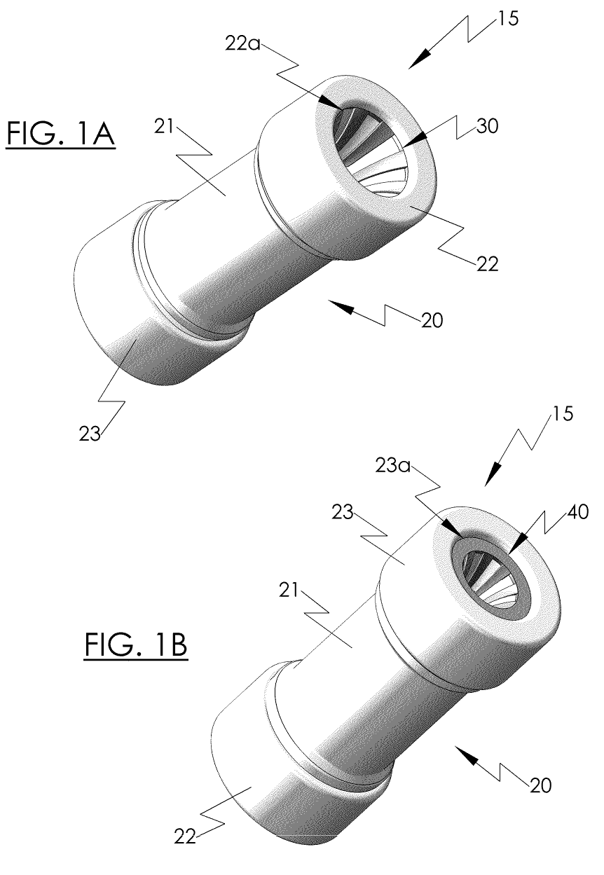

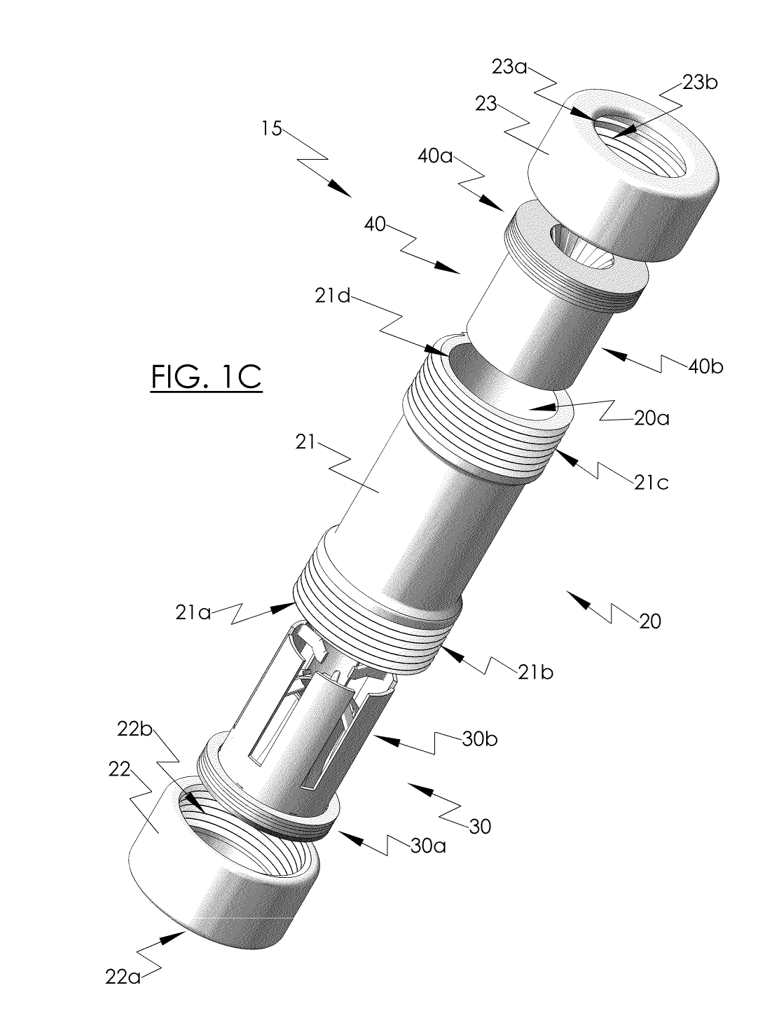

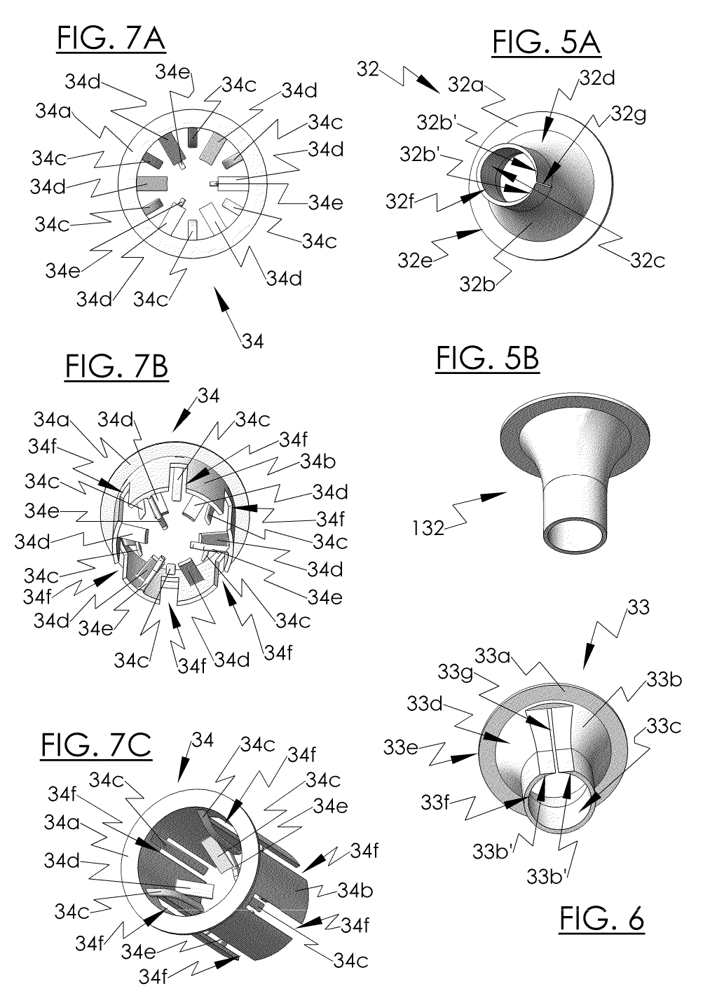

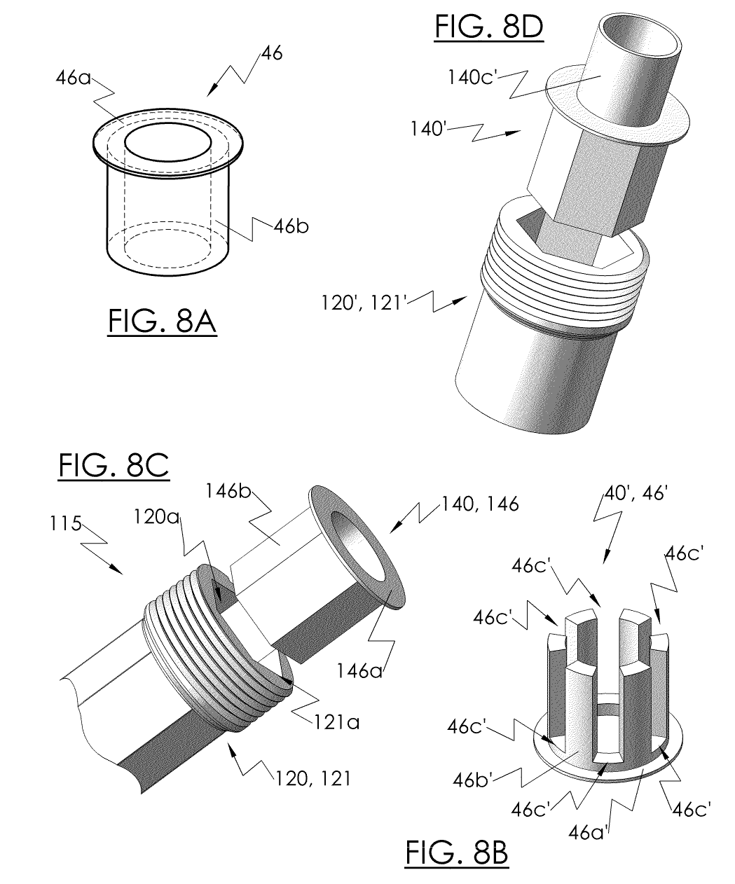

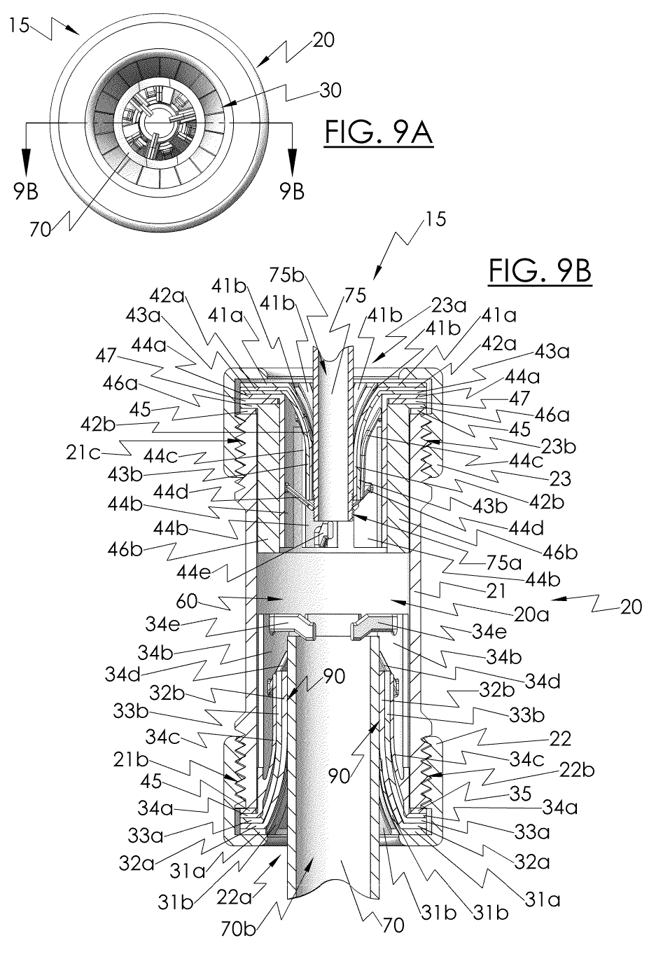

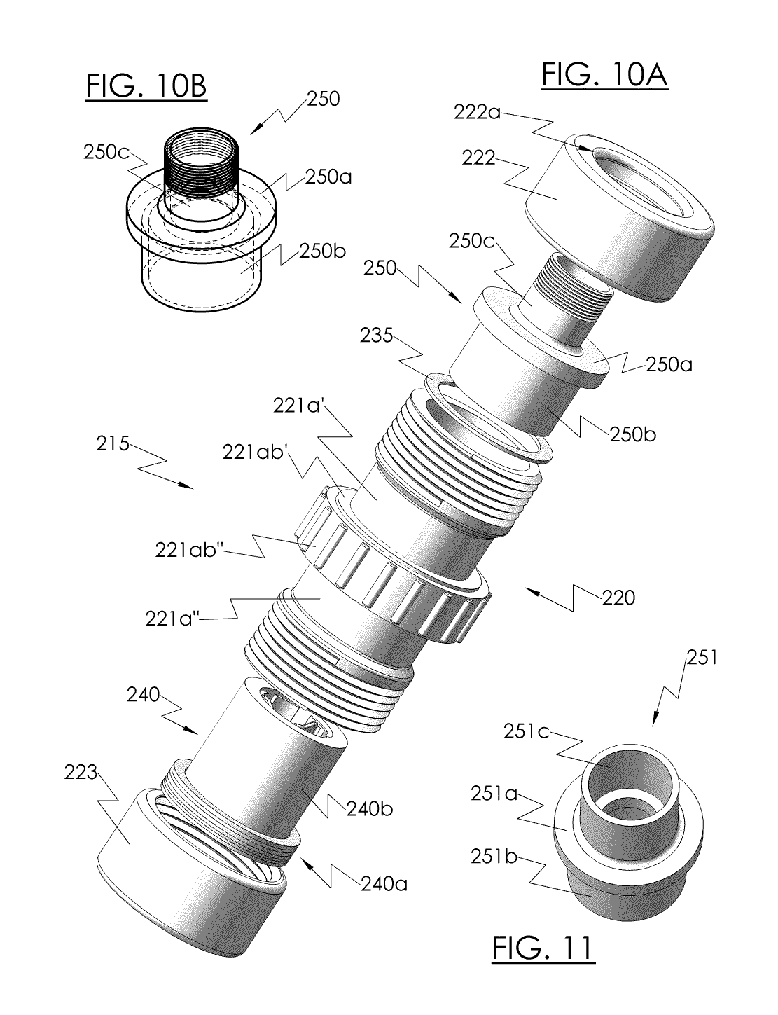

One embodiment of the present invention 15 is illustrated in FIG. 1A through FIG. 9B, but excluding FIG. 5B and FIG. 8B through FIG. 8D. FIG. 9B presents a sectional view of the device 15 illustrated in FIG. 1A through FIG. 1C, which serves to illustrate the interior components and operation of the device 15. FIG. 1C presents an exploded perspective view of the device 15 illustrated in FIG. 1A and FIG. 1B. In this illustrated embodiment of the present invention, the device 15 is comprised of a casing member 20 and at least one first modular connector (variable connecting member 30 in this embodiment). The casing member 20 is further comprised of modular connecting means, which are described in more detail below, adapted for connecting the casing member 20 to the at least one first modular connector (variable connecting member 30). The at least one first modular connector (variable connecting member 30) further comprises modular connecting means for connecting the at least one first modular connector (variable connecting member 30) to the casing member 20. The casing member 20 is also adapted to be connected to at least one second modular connector (variable connecting member 40 in this embodiment) that comprises the same operative modular connecting means (described in more detail below) as that comprising the at least one first modular connector (variable connecting member 30). Thus, the at least one first modular connector (variable connecting member 30) is interchangeable with the at least one second modular connector (variable connecting member 40) in its operation with the casing member 20 as part of a modularized system of interchangeable modular connectors (variable connecting members 30, 40). Each of the modular connectors (variable connecting members 30, 40) is also comprised of duct connecting means for connecting the modular connector (variable connecting members 30, 40) to at least one duct (not illustrated), as described in more detail below. Generally, the modular connectors (variable connecting members 30, 40) comprising the system may have more than one type of duct connecting means, as described in more detail below. Thus, although each of the modular connectors (variable connecting members 30, 40) in this embodiment is comprised of variable connecting means, which allows it to be connected to a variety of sizes and shapes of ducts (not illustrated), the modular connectors (variable connecting members 30, 40) may comprise other duct connecting means in other embodiments, all as described in more detail below. For example, the modular connectors may have as duct connecting means a male iron pipe (MIP) adapter, a female iron pipe (FIP) adapter, a slip adapter, an adapting tee, a casing connector (for connecting casing members 20 together), an adapting casing connector (for connecting different sizes of casing members 20 together), and an adjusting modular connector (for connecting casing members 20 to modular connectors having a different modular connecting means), all as described in more detail below and illustrated in connection with FIG. 10A through FIG. 18C. In its various embodiments, the present invention may be comprised of the casing member 20, each of the modular connectors (variable connecting members 30, 40), and one or more of the ducts (not illustrated), together or in any combination thereof. The various components comprising the present invention are now described in more detail.

As illustrated in the device 15 of FIG. 9A and FIG. 9B as an example, the ducts (pipes 70, 75) that are connected to the device 15 may have a tubular shape and may be comprised in whole or in part of conduit, tubing (including medical or food grade tubing), pipeline, duct, hose, channel, vent or other similar objects or combinations of such objects that may be currently known in the relevant art or that may be developed in the relevant art in the future. The ducts (pipes 70, 75) may also have other shapes in other embodiments. For example, the ducts (pipes 70, 75) may have a cross-section that is approximately elliptical, triangular, square, rectangular, pentagonal, hexagonal, another polygonal shape, or another shape or combination of such shapes. The ducts (pipes 70, 75) may also be comprised of any materials suitable for constructing conduit, tubing, pipeline, duct, hose, channel, vent or similar objects. Examples include metals (such as steel, steel alloys, aluminum, copper, brass, or other metals or metal alloys), polymers (such as polyvinyl chloride (PVC), polyethylene, acrylonitrile butadiene styrene (ABS), rubber, synthetic rubber (including NEOPRENE), silicon, and other polymers), wood, glass, fiberglass, carbon-based and other composites, or other materials or a combination of such materials. Further, the ducts (pipes 70, 75) may have a variety of different thread types on the end thereof. For example, the ducts (pipes 70, 75) may have American Standard Pipe Taper Threads (NPT), American Standard Straight Coupling Pipe Threads (NPSC), American Standard Taper Railing Pipe Threads (NPTR), American Standard Straight Mechanical Pipe Threads (NPSM), American Standard Straight Locknut Pipe Threads (NPSL), American Standard Pipe Taper Threads (Dryseal; NPTF), American Fuel Internal Straight Pipe Thread (NPSF), British Standard Pipe Threads (tapered—BSPT, and parallel—BSPP), or any other type of threads. Alternatively, the duct (pipe 15) may have no threads or a different type of connector means (such as a VICTAULIC® groove) on the end thereof. It is also to be noted that the device 15 of the present invention may be used for ducts (pipes 70, 75) transporting gases or liquids or both, so that references to a “fluid” herein are intended to refer to both gases and liquids, as they may be carried by the ducts (pipes 70, 75) in each case. In still other embodiments, the ducts (pipes 70, 75) may comprise fittings or other connecting devices.

In the embodiment of the present invention illustrated in FIG. 1A through FIG. 9B (excluding FIG. 5B and FIG. 8B through FIG. 8D), the device 15 is generally comprised of a casing member 20, two modular connectors (variable connecting members 30, 40 in this embodiment), and modular connecting means, all of which are described in more detail below. In the illustrated embodiment of the device 15, as best illustrated in FIG. 1A through FIG. 1C, the casing member 20 is further comprised of a hollow, approximately tubular-shaped case body 21, a case cap 22, 23 positioned at each end of the case body 21, and modular connecting means, which are described in more detail below. Case cap 23 may have any of the characteristics, features, structure, functions and operation as case cap 22, as described in more detail elsewhere herein. The case caps 22, 23 each have a connector opening 22a, 23a, respectively, positioned therein. The case caps 22, 23 may be removably or permanently connected to the case body 21 by case cap connecting means, which are described in more detail below. Although the case body 21 is approximately tubular-shaped in the illustrated embodiment, the casing member 20 may have other shapes in other embodiments of the device 15, as long as the casing member 20 has an interior space 20a and a connector opening 22a (and other connector openings 23a in some embodiments) each adjoining the interior space 20a, wherein the connector openings 22a, 23a are of a size and shape adapted to cooperate with the modular connectors (variable connecting members 30, 40) in operation of the device 15, all as described in more detail below. As an example of an alternate shape, as illustrated by the case body 121 illustrated in FIG. 8C, a portion of the exterior surface of the case body 121 (and portions of the casing member 120) may be hexagonal in shape when viewed in cross-section from above an end of the case body 121. This shape may assist the user of the device 115 in holding the case body 121 with a pipe wrench, adjustable wrench, or other tool in operation of the device 115. Referring again to the embodiment of the present invention illustrated in FIG. 1A through FIG. 9B (excluding FIG. 5B and FIG. 8B through FIG. 8D), the case body 21 may also have approximately elliptical, triangular, square, rectangular, pentagonal, another polygonal shape, other shapes having arcuate or linear portions, or another shape or combination of such shapes, as long as the casing member 20 cooperates with the modular connectors (variable connecting members 30, 40) in operation of the device 15, all as described in more detail below. Further, the case body 21 may also be comprised of two or more component parts, where such component parts are connected together by any appropriate means, such as a threaded connection, clasps, clamps, clips, pins, hinges, adhesives, epoxies, welding, fusing, nails, screws, nuts, bolts, or other types of fasteners or connectors, either alone or in conjunction with one another in different combinations. An example of this type of construction is illustrated by the casing member 220, which generally comprises a union, as described in more detail below and illustrated in connection with FIG. 10A.

Referring again to the embodiment of the present invention illustrated in FIG. 1A through FIG. 9B (excluding FIG. 5B and FIG. 8B through FIG. 8D), the preferred size and shape of the case body 21 are dependent upon a number of factors, such as the anticipated size or range of sizes of the ducts (pipes 70, 75), the size, shape and configuration of the modular connectors (variable connecting members 30, 40), the anticipated operating pressures of the device 15 (i.e., the pressures expected in the chamber 60, as illustrated and described in more detail below in conjunction with FIG. 9B), the materials comprising the case body 21, the type of modular connecting means (described in more detail below) utilized in the device 15, the preferences of the user of the device 15, and other factors. The preferred wall thickness of the case body 21 is generally dependent upon the same types of factors. In addition, the case body 21 may be comprised of any suitable type of material. For example, the case body 21 may be comprised of metal (such as steel, steel alloys, aluminum, copper, brass, or other metals or metal alloys), polymers (such as PVC, polyethylene, polypropylene, ABS, and other polymers), wood, fiberglass, carbon-based or other composites, or other materials or a combination of such materials. The preferred material is dependent upon a number of different factors, such as the anticipated size, shape and type of the ducts (pipes 70, 75), the type of connection to be made to the ducts (pipes 70, 75), the size, shape, material composition and configuration of the modular connectors (variable connecting members 30, 40), the anticipated operating pressures of the device 15 (i.e., the pressures expected in the chamber 60, as described in more detail below), the anticipated operating or installation temperatures of the device 15, the type of fluid carried by the ducts (pipes 70, 75), the desired wall thickness and weight of the case body 21, the preferences of the user of the device 15, and other factors. The case body 21 may be fabricated using any suitable means. For example, a case body 21 constructed of PVC may be formed by injection molding and a case body 21 constructed of a metal alloy may be formed by metal injection molding. In the case of a device 15 designed for use with room temperature domestic potable water and capable of accommodating pipes 70, 75 in the range of ¾″ to ½″ nominal diameter, the case body 21 is preferably tubular in shape, is constructed of polyvinyl chloride, has an inside diameter of approximately 1½ inches, and has a wall thickness in the range of approximately ⅛ inch to 3/16 inch.

In the embodiment of the device 15, as best illustrated in FIG. 1A through FIG. 1C, the case cap 22 is approximately cylindrical in shape and may be permanently or removably attached to the open end 21a of the case body 21 adjacent to the case cap 22 by the case cap connecting means, which are described in more detail below. In the illustrated embodiment, which is the preferred embodiment, the case cap connecting means are comprised of threads 21b on the outside surface of the portion of the case body 21 adjacent to the open end 21a of the case body 21 and corresponding threads 22b on the interior surface of the tubular portion of the case cap 22. Thus, the case cap 22 may be placed over the open end 21a of the case body 21, and may then be screwed down onto the case body 21. In this embodiment, when the case cap 22 is screwed down onto the case body 21, a portion of the modular connector (variable connecting member 30) is compressed between the case cap 22 and the case body 21, holding the modular connector (variable connecting member 30) in place relative to the casing member 20 and forming a fluid-tight seal between the modular connector (variable connecting member 30) and the case body 21, all as described in more detail below and as more particularly illustrated in connection with FIG. 1C and FIG. 9B. In other embodiments, the threads 21b, 22b may be oriented in a different configuration. For example, the threads 21b on the case body 21 may be positioned on the interior surface of the case body 21, and the corresponding threads 22b of the case cap 22 may be positioned on the exterior surface of a disc-shaped case cap 22. In this embodiment, the case cap 22 is screwed into the case body 21, holding the modular connector (variable connecting member 30) in place relative to the casing member 20 and forming a fluid-tight seal between the modular connector (variable connecting member 30) and the case body 21 in a manner similar to that described above.

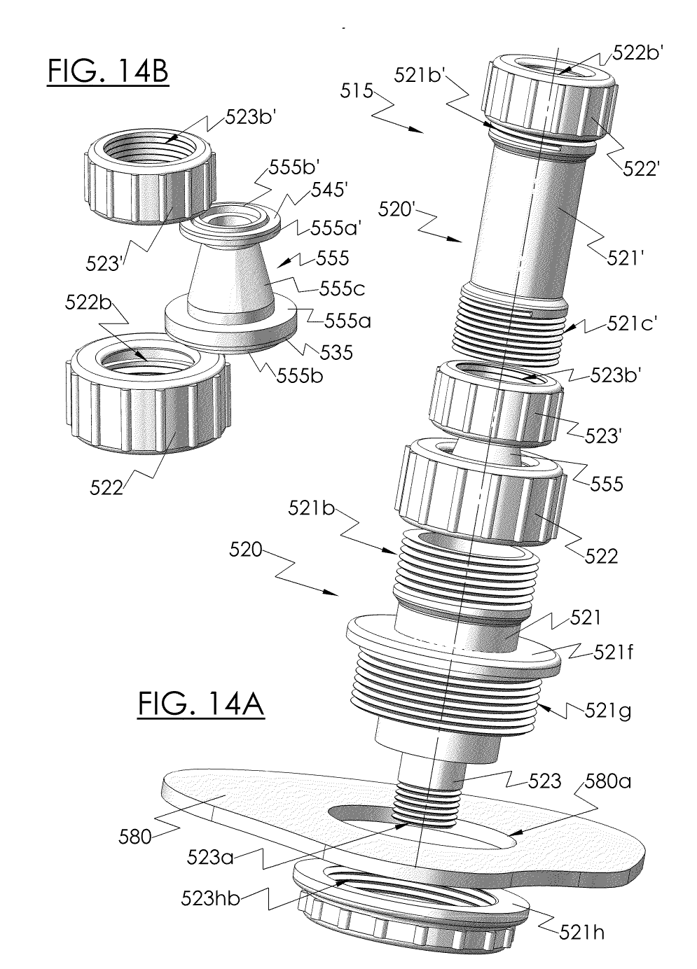

It is to be noted that in other embodiments the case cap 22 may have a different shape, as long as the case cap 22 cooperates with the case body 21 and the modular connector (variable connecting member 30) to accommodate the operation of the device 15, as described in more detail herein. For example, the case cap 22 may facilitate a fluid-tight seal between the case body 21 and the modular connector (variable connecting member 30) in this embodiment, as described in more detail below. In addition, the connector opening 22a may be of almost any size and shape, as long as it cooperates with the modular connecting means (described in more detail below) in connecting the modular connector (variable connecting member 30) to the case body 21 and permitting the modular connector (variable connecting member 30) to be connected to the duct (pipe 70), which means that the pipe 70 may be inserted into the casing member 20 and the modular connector (variable connecting member 30) in this embodiment. In other embodiments, the connector opening 22a is of a size and shape adapted to have the duct connecting means (variable connecting member 30) positioned within the connector opening 22a. The case cap 22 may generally be comprised of any materials or combinations of materials that may be used to construct the case body 21, as described in more detail above and illustrated in connection with FIG. 1A through FIG. 1C. Although the case cap 22 need not be constructed of the same material as the case body 21, the case cap 22 is preferably constructed of the same material. The case cap 22 may be fabricated using any suitable manufacturing means. For example, a case cap 22 comprised of PVC may be formed by injection molding and a case cap 22 comprised of a metal or metal alloy may be formed by metal injection molding. In some embodiments, as illustrated in FIG. 14A and FIG. 14B, the case caps 522, 522′, 523′ may have protruding ridges on the exterior surface thereof that assist the user in gripping the case cap 522, 522′, 523′, particularly when the case cap 522, 522′, 523′ is being screwed onto or off of the case body 521, 521′, respectively.

In addition, and referring again to the embodiment of the present invention best illustrated in FIG. 1A through FIG. 1C, the case cap connecting means may be comprised of means other than the illustrated threads 21b, 22b, as long as they cooperate with the modular connecting means (described in more detail below) in connecting the modular connector (variable connecting member 30) to the case body 21 and are adapted to cooperate with the modular connector (variable connecting member 30) in operation of the device 15, all as described in more detail below. In the illustrated embodiment, such operation means, among other things, that the case cap connecting means permit the connector openings 22a, 23a to be of a size and shape adapted to receive the duct (pipe 70). For example, other case cap connecting means that may be used to removably connect the case cap 22 to the case body 21 comprise clasps, clamps, clips, pins, hinges, other pivoting connectors or other types of connectors, either alone or in conjunction with one another in different combinations. Examples of case cap connecting means that may be used to permanently connect the case cap 22 to the case body 21 include adhesives, epoxies, welding, fusing, nails, screws, nuts, bolts, or other fasteners or a combination of such means. Where the modular connector (variable connecting member 30) may be positioned within the interior space 20a of the casing member 20 other than through the open end 21a of the case body 21, the case cap 22 may also be fabricated as a part of the case body 21. It is to be noted, however, that the case cap connecting means may or may not be utilized to facilitate a fluid-tight seal between the modular connector (variable connecting member 30) and the case body 21. In some embodiments, a fluid-tight seal may be inherent in the type of case cap connecting means used (such as welding or fusing), or it may be created in whole or in part by the modular connecting means (as described in more detail below) or additional sealing means, such as o-rings, gaskets, flanges, washers, or other similar types of means or combinations of such means, as described in more detail below. The preferred characteristics of the case cap 22 and case cap connecting means are dependent upon a number of different factors, such as the anticipated range of shapes and sizes of the duct (pipe 70), the size, shape, material composition and configuration of the modular connector (variable connecting member 30), the type of modular connecting means (which are described in more detail below), the anticipated operating pressures of the device 15 (i.e., the pressures expected in the chamber 60, as described in more detail below), the materials comprising and the shape of the case body 21, the preferences of the user of the device 15, and other factors. More preferred, the case cap 22 is generally of the shape illustrated in FIG. 1A through FIG. 1C and has a threaded case cap connecting means. It is to be noted that the case cap 23 may have substantially the same structure, features, characteristics, functions and operation as the case cap 22 described above and illustrated in connection with FIG. 1A through FIG. 1C. The case cap 23 may be permanently or removably connected to the case body 21 at the case body open end 21d using case cap connecting means (threads 21c, 22c) in substantially the same manner as described above for case cap 22 and its associated modular connector (variable connecting member 30).

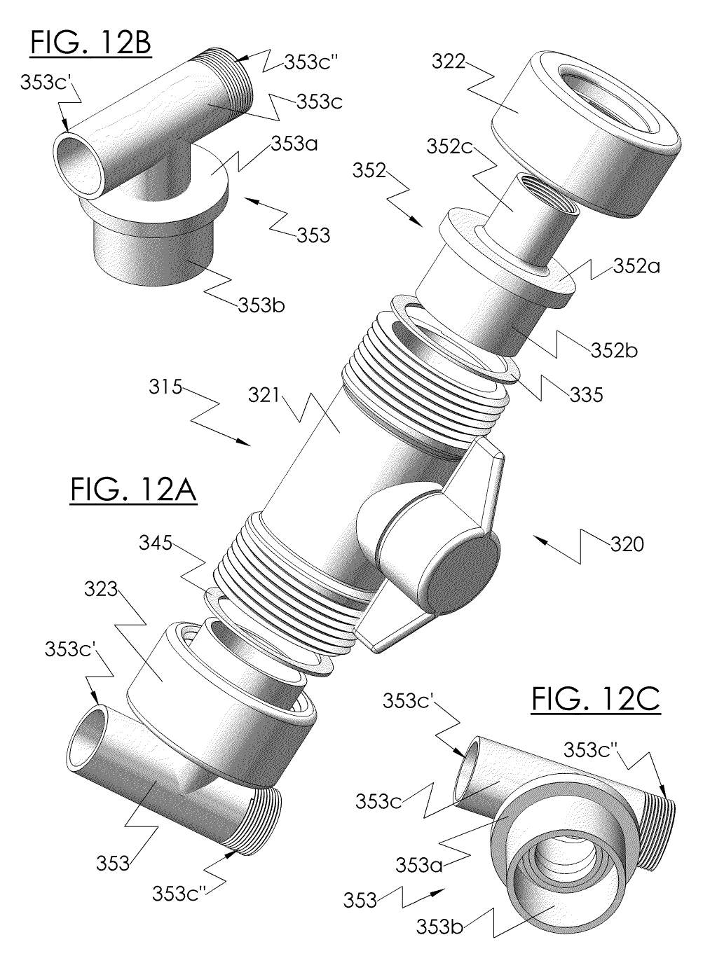

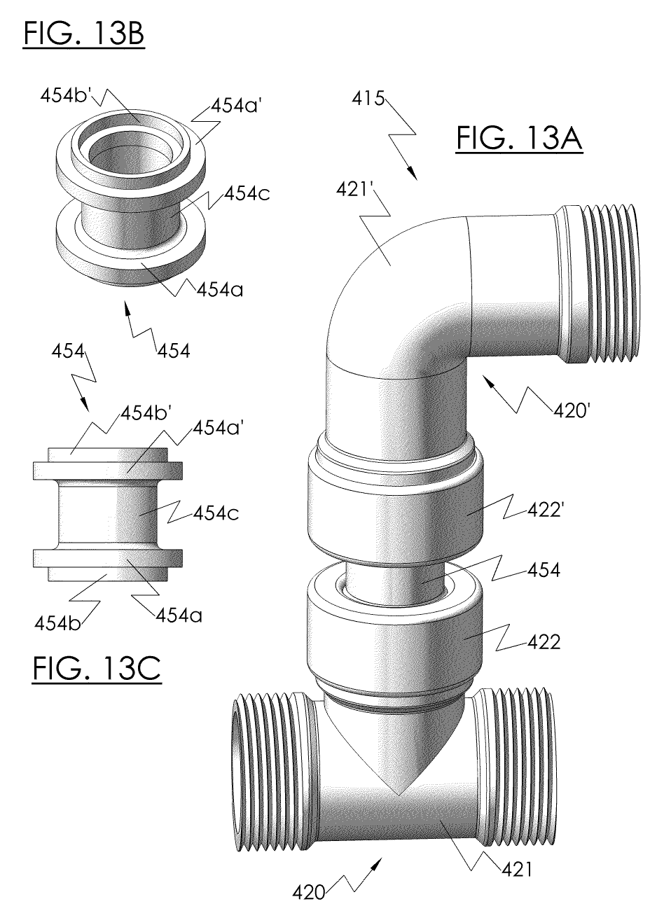

In the embodiment of the device 15 illustrated in FIG. 1A through FIG. 1C, the casing member 20, as well as the modular connectors (variable connecting members 30, 40), are each further comprised of modular connecting means, which are described in more detail below. Generally, the modular connecting means allow each of the modular connectors (variable connecting members 30, 40) to be operatively connected to the casing member 20, as described in more detail below. In addition, the device 15 (comprising the casing member 20 and the modular connectors (variable connecting members 30, 40)) may be incorporated in a variety of ways in any standard types of fittings, which may be fabricated as a part of or be attached to the casing member 20. For example, as illustrated in FIG. 1A through FIG. 1C and FIG. 9B, the casing member 20 may be fabricated as a portion of device 15 that acts as a coupling. In this embodiment, one of the modular connectors (variable connecting member 30, 40) may be connected to each end of the casing member 20, so that two modular connectors (variable connecting members 30, 40) may be connected to the casing member 20. As another example, as illustrated in FIG. 10A, the device 215 comprises a casing member 220 that is generally in the form of a union. In this embodiment, the casing member 220 is further comprised of a two-part case body 221a′, 221a″ and case caps 222, 223 that are adapted to be connected to the ends of the case body 221a′, 221a″, respectively, using case cap connecting means, which may be any of the case cap connecting means described above and illustrated in connection with FIG. 1A through FIG. 1C. The two parts of the case body 221a′, 221a″ are connected together by a threaded collar portion 221ab″ (which is a portion of one part 221a″) that fits over and is screwed down onto a threaded ridge portion 221ab′ (which is a portion of the other part 221a′). This device 215 also illustrates how different types of modular connectors 240, 250 may be used with the casing member 220. For example, a modular connector 240 comprising variable connecting means (such as variable connecting member 40 described in more detail herein and illustrated in connection with FIG. 1A through FIG. 9B) is connected to one end of the casing member 220 and a modular connector 250 comprising an MIP adapter is connected to the other end of the casing member 220. As yet another example, as illustrated in FIG. 12A, the casing member 320 comprising the device 315 may take the form of a valve or similar device. In such cases, the casing member 320 may comprise any type of valve or flow regulating mechanism currently known in the relevant art or that may be developed in the relevant art in the future. For example, the casing member 320 may comprise a check-valve, gate valve, ball valve, pressure regulator, backflow prevention device, needle valve, or a combination of such devices. As other examples, as illustrated in FIG. 13A, the casing member 420 may be in the form of a tee, or the casing member 420′ may be in the form of a 90 degree elbow. Casing members 420′ shaped as an elbow may also have bends of 45 degrees, 22½ degrees, or another bend angle.

As yet another example, as illustrated in FIG. 14A, the casing member 520 need not be comprised solely of openings adapted for receiving modular connectors (such as modular connector 555). In such embodiments, the casing member 520 may be further comprised of an object open end 523a and object connecting means (MIP adapter 523 in this embodiment) that are used to connect an object (not illustrated) to the casing member 520 at the object open end 523a. The object may generally comprise any of the structures, features or characteristics of the ducts (not illustrated, but which may be similar to the pipes 70, 75 described below and illustrated in connection with FIG. 9A and FIG. 9B that may be connected to the device 15). In addition, the object may be comprised in whole or in part of equipment, machinery, containers, tanks, or other objects or a combination of such objects to which it may be desirable to connect one or more ducts in a manner that provides for fluid communication between the interior space of the object with the interior space of the duct, as described in more detail below. In the embodiment of the device 515 illustrated in FIG. 14A, the object connecting means are comprised of a male iron pipe (MIP) adapter 523 fabricated as a part of, and positioned at one end of, a case body 521. Also, in this embodiment, the MIP adapter 523 is positioned on the case body 521 so that the longitudinal axis of the MIP adapter 523 is collinear with the longitudinal axis of the case body 521. In other embodiments, the MIP adapter 523 (or other object connecting means) may be positioned on a different portion of the case body 521 or have a different orientation relative to the case body 521, as long as the position does not adversely affect the operation of the device 515, as described in more detail herein. For example, the MIP adapter 523 may extend from the sidewall of the case body 521 (as opposed to from the end of the case body 521) and may be oriented at a 45 degree angle relative to the longitudinal axis of the case body 521. In the illustrated embodiment, the MIP adapter 523 may be fabricated as a part of the case body 521, which is the preferred means of fabrication, or it may be fabricated separately from the case body 521 and attached to the case body 521 by any suitable means, such as adhesives, epoxies, welding, fusing, nails, screws, clips, clamps, nuts, bolts, or other fasteners or a combination of such means.

Referring to the embodiment of the device 515 illustrated in FIG. 14A as an example, the object connecting means (MIP adapter 523) may be comprised of almost any means that may be used for making a fluid-tight connection. For example, the object connecting means may be comprised of a female iron pipe (FIP) adapter. As other examples, the object connecting means may be comprised of welding, fusing, adhesives, glues, epoxies, a garden hose connector, a connector having any type of the threads (male or female), luer lock fittings, SWAGELOK® fittings, quick connect/disconnect fittings, hose barbs, stepped tubing connectors, bushings, flanges, compression fittings, tubing and hose connectors, SPEEDFIT® connectors, couplings for connection using clamps or adhesives, or other means or a combination of such means. In addition, the object connecting means may be comprised in whole or in part of a segment of conduit, tubing (including medical or food grade tubing), pipeline, duct, hose, channel, vent, a spout or other outlet or inlet member, or other similar objects or a combination of such objects extending from a portion of the casing member 520. The preferred object connecting means for use with any particular embodiment of the device 515 depends upon a number of factors, such as the anticipated size, shape and type of materials comprising the object, the anticipated operating pressures of the device 515, the anticipated operating or installation temperatures of the device 515, the materials comprising and the shape and size of the casing member 520, the preferences of the user of the device 515, and other factors. More preferably, for an MIP adapter 523 comprised of PVC that is used to connect a pipe (not illustrated), the MIP adapter 523 is positioned and oriented as illustrated in FIG. 14A and is fabricated as a part of the case body 521 by injection molding.

Continuing to refer to FIG. 14A, the object connecting means may also be used to connect the casing member 520 to the side wall of another pipe. Further, the object connecting means may also be comprised in whole or in part of another variable connecting means (which are described in more detail below) of the present invention. Further still, the object connecting means may be comprised in whole or in part of the object, such as a tank, container, machine or item of equipment or any portion of the same. For example, the object connecting means may be comprised of the case body 521 being a part of or affixed to the side wall of a tank (not illustrated), so that the device 515 connects a duct (not illustrated) to the interior space of the tank (which would comprise the object in this embodiment). As another example, the case body 521 may be a part of or affixed to a panel on a piece of machinery or equipment (panel 580 in the illustrated embodiment), so that the device 515 connects the duct to the portion of the machinery that utilizes fluid supplied by the duct. An embodiment of this type of connection is illustrated in FIG. 14A, in which the object connecting means of the device 515 is comprised of a collar member 521f that extends around the circumference of the case base 521. In this embodiment, the equipment panel or the boundary wall of a container 580 has an opening 580a therein. The case body 521 is inserted into the opening 580a in the panel or boundary wall 580 until it abuts up against the collar member 521f. In this embodiment, the panel or boundary wall 580 is held in place against the collar member 521f by a lock nut 521h. The lock nut 521h has threads 521hb that correspond to threads 521g on the case body 521 adjacent to the collar member 521f, so that the lock nut 521h is screwed down onto the case body 521 threads 521g until the panel or boundary wall 580 is held tightly between the collar member 521f and the lock nut 521h. In other embodiments, the panel or boundary wall 580 may be held in place against the collar member 521f by any suitable means, such as clasps, clamps, clips, pins, dowels, adhesives, epoxies, welding, fusing, nails, screws, nuts, bolts, flanges or other means or a combination thereof. Alternatively, the case body 523 and the panel or boundary wall 523 may be fabricated together as a single component.

As is readily apparent to one skilled in the relevant art, and referring to the device 15 illustrated in FIG. 1A through FIG. 1C as an example, the casing member 20 of the present invention may take the form of almost any type of fitting or joining or coupling system currently known in the relevant art or that may be developed in the relevant art in the future. All of such fittings and coupling and joining systems incorporating the modular connecting means may be included within the spirit and scope of the invention as defined by the appended claims.

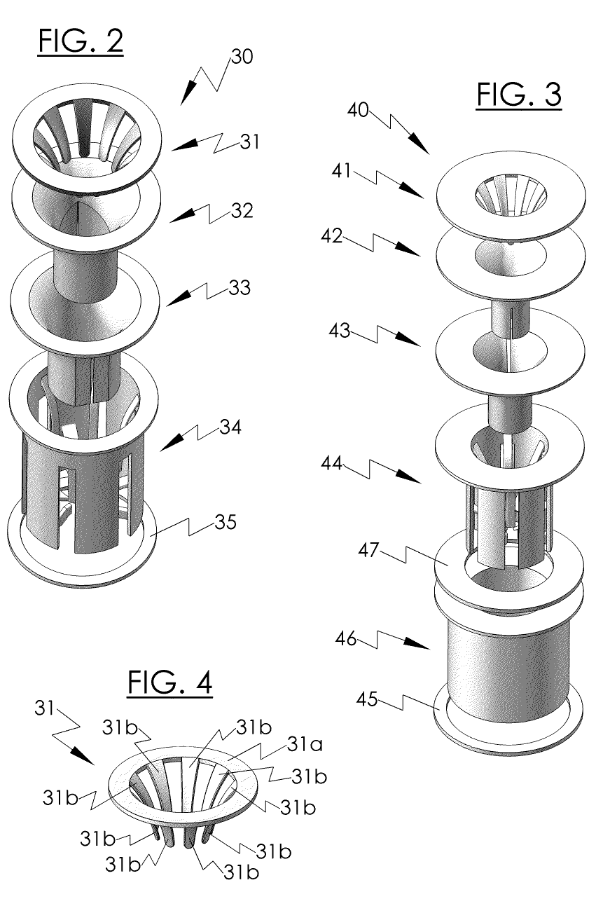

Generally, and referring to the device 15 illustrated in FIG. 1A through FIG. 9B as an example, the modular connectors (variable connecting members 30, 40) of the device 15 are comprised of modular connecting means and duct connecting means, which are described in more detail below. In addition, the casing member 20 is comprised of modular connecting means. In the illustrated embodiment, and referring to the variable connecting member 30 best illustrated in FIG. 1C as an example, the modular connecting means are comprised of a connector flange portion 30a and a connector shell portion 30b that cooperate with the portion of the case body 21 adjacent to the case body open end 21a and the portion of the case cap 22 adjacent to the connector opening 22a to permit the modular connector (variable connecting member 30) to be connected to the casing member 20. In this embodiment, the modular connecting means also comprise a washer 35 (see FIG. 2 and FIG. 9B) that assists in forming a fluid-tight seal between the modular connector (variable connecting member 30) and the casing member 20 so that fluids contained within the chamber 60 (as described in more detail below) do not leak out through the seams formed between the modular connector (variable connecting member 30) and the casing member 20. Although a fluid-tight seal is preferably formed between the modular connector (variable connecting member 30) and the casing member 20, a fluid-tight seal need not be formed in all embodiments. In the illustrated embodiment, the connector flange portion 30a and the connector shell portion 30b are generally shaped approximately as an annulus and a cylinder, respectively. The portion of the case cap 22 adjacent to the connector opening 22a is approximately annular in shape, while the portion of the case body 21 adjacent to the case body open end 21a is annularly shaped at its open end 21a, with a cylindrical portion bounding the case body interior space 20a that extends away from such end 21a. The shapes and sizes of these components (variable connecting member 30, case body 21, and case cap 22) is such that the connector shell portion 30b fits within the cylindrical portion of the case body 21 adjacent to the casing interior space 20a, while the flange portion 30a (including washer 35) of the variable connecting member 30 is positioned adjacent to and compressed between the annular portion of the case body 21 adjacent to the case body open end 21a and the annular portion of the case cap 22 adjacent to the connector opening 22a. Thus, the modular connector (variable connecting member 30) is connected to the casing member 20 by the modular connecting means, which generally comprise the size and shape of the components (variable connecting member 30, case body 21, and case cap 22) and the case cap connecting means operating in cooperation with one another.

It is to be noted that the casing member 20 and the other modular connector (variable connecting member 40) of the embodiment of the device 15 best illustrated in FIG. 1A through FIG. 1C incorporate the same modular connecting means described above with respect to variable connecting member 30, so that variable connecting member 40 is interchangeable with variable connecting member 30 in operation of the device. For example, the portion of the case body 21 adjacent to the other open end 21d of the case body 21 and the case cap 23 have features and characteristics that are operatively the same as those for the portion of the case body 21 adjacent to the open end 21a of the case body 21 and the case cap 22, respectively, described above. In addition, the variable connecting member 40 is also comprised of a connector flange portion 40a and a connector shell portion 40b that cooperate with the portion of the case body 21 adjacent to the case body open end 21d and the portion of the case cap 23 adjacent to the duct opening 23a to permit the variable connecting member 40 to be connected to the casing member 20. Thus, the connector flange portion 40a and the connector shell portion 40b are shaped approximately as an annulus and a cylinder, respectively, and are generally of the same cross-sectional size and shape as the connector flange portion 30a and the connector shell portion 30b, respectively. The portion of the case cap 23 adjacent to the connector opening 23a is approximately annular in shape, while the portion of the case body 21 adjacent to the case body open end 21d is annularly shaped at its open end 21d, with a cylindrical portion bounding the case body interior space 20a that extends away from such end 21d. The shapes and sizes of these components (variable connecting member 40, case body 21, and case cap 23) is such that the connector shell portion 40b fits within the cylindrical portion of the case body 21 adjacent to the casing interior space 20a, while the connector flange portion 40a (including washer 45, as illustrated in FIG. 3 and FIG. 9B) of the variable connecting member 40 is positioned adjacent to and compressed between the annular portion of the case body 21 adjacent to the case body open end 21d and the annular portion of the case cap 23 adjacent to the duct opening 23a. As a result, the modular connector (variable connecting member 40) is connected to the casing member 20 by modular connecting means that are operatively equivalent to the modular connecting means used to connect variable connecting member 30 to the casing member 20. Consequently, variable connecting member 40 may be connected to the casing member 20 at the open end 21a of the case body 21, and variable connecting member 40 may be connected to the casing member 20 at the other open end 21d of the case body 21, in each case using the modular connecting means described above and illustrated in connection with the device 15 illustrated in FIG. 1A through FIG. 9B.

The modular system of the present invention is not limited to modular connectors (variable connecting members 30, 40) comprising variable connecting means. For example, as illustrated in FIG. 10A, the device 215 may comprise a casing member 220 and modular connectors 240, 250 having different duct connecting means (which are described in more detail below). In this embodiment, the casing member 220 has substantially the same modular connecting means as the casing member 20 described in more detail above and illustrated in connection with FIG. 1A through FIG. 9B. In addition, one modular connector 240 has substantially the same structure, features, characteristics, functions and operation as the modular connector 40 described in more detail elsewhere herein and illustrated in connection with FIG. 1A through FIG. 9B. Thus, this modular connector 240 has modular connecting means that is operatively the same as that comprising modular connector 40. The other modular connector 250 is comprised of an annular shaped connector flange portion 250a and an approximately cylindrical connector shell portion 250b that extends away from the connector flange portion 250a. This embodiment of modular connector 250, showing hidden lines in phantom, is illustrated in FIG. 10B. The connector flange portion 250a and the connector shell portion 250b are generally of the same cross-sectional size and shape as the connector flange portion 240a and the connector shell portion 240b, respectively, of the modular connector 240. The modular connector 250 is also comprised of an MIP adapter portion 250c that acts as duct connecting means, which are generally described in more detail below. The MIP adapter 250c is of a size and shape adapted so that it extends through the connector opening 222a of the case cap 222. Thus, the modular connecting means of the modular connectors 240, 250 and casing members 20, 220 are operatively equivalent, so that both modular connectors 240, 250 may be connected to any end of either of the casing members 20, 220, and the modular connector 30 may be connected to either end of casing member 220.

An embodiment of another modular connector 251 is illustrated in FIG. 11. This modular connector 251 is also comprised of an annular shaped connector flange portion 251a, an approximately cylindrical connector shell portion 251b that extends away from the connector flange portion 250a, and a slip adapter portion 250c. The connector flange portion 251a and the connector shell portion 251b are generally of the same cross-sectional size and shape as the connector flange portions 240a, 250a and the connector shell portions 240b, 250b respectively, of the modular connectors 240, 250. Thus, the modular connector 251 may also be connected to any end of either of the casing members 20, 220. The same is also true of the modular connectors 352, 353 and the casing member 320 illustrated in FIG. 12A through FIG. 12C. The casing member 320 is generally comprised of modular connecting means that is operatively the same as that for casing member 20. In addition, the modular connector 352 is comprised of an annular shaped connector flange portion 352a, an approximately cylindrical connector shell portion 352b that extends away from the connector flange portion 352a, and an FIP adapter portion 352c. The modular connector 353 is also comprised of an annular shaped connector flange portion 353a, an approximately cylindrical connector shell portion 353b that extends away from the connector flange portion 353a, and an adapting tee portion 353c, which is described in more detail below. Because the connector flange portions 352a, 353a and the connector shell portions 352b, 353b are generally of the same cross-sectional size and shape as the connector flange portions 240a, 250a and the connector shell portions 240b, 250b respectively, the modular connectors 352, 353 may also be connected to any end of either of the casing members 20, 220. Similarly, any of the modular connectors 30, 40, 240, 250, 251 may also be connected to either end of the casing member 320. As is the case with modular connector 353, it is to be noted that in some embodiments the case cap 323 (as a portion of the modular connecting means) may be incorporated as a part of the modular connector 353.

Use of the modular connecting means does not, however, require that the pertinent portions of the modular connectors have the exact same shape in every embodiment of the modularized system. For example, as illustrated in FIG. 13A through FIG. 13C, the modular connector 454 (which acts as a casing connector, as described in more detail below) may have a connector flange portion 454a that is the same as that for modular connectors 240, 250 (illustrated in FIG. 10A and FIG. 10B), but may have a connector shell portion 454b that is not the same length as that for modular connectors 240, 250. In this embodiment of modular connecting means, the length of the connector shell portion 454a is generally flexible. As long as the modular shell portion 454a is not too long to be accommodated by the device 415, but long enough to accommodate the proper positioning of the modular connector 454a within the end of the casing member 454a, the device 415 will function as intended, so that the modular connecting means are operatively the same. Another example of this type of modular connector 555 is illustrated in the device 515 of FIG. 14A and FIG. 14B, in which the modular connector 555 also has shortened connector shell portions. This modular connector 555 also acts as an adjusting casing connector to connect casing members 521, 521′ of different types of modular systems together, as described in more detail below. The variable connector adjusting member 46′ illustrated in FIG. 8B represents yet another variation in the geometry that may comprise the modular connecting means. In this embodiment, the connector shell portion 46b′ (as an alternative embodiment of the adjusting member shell portion 46 of modular connector 40) has a plurality of slits 46c′ that extend along the adjusting member shell portion 46b′. Again, there may be any type, shape or size of such geometry present, comprising operatively equivalent modular connecting means, as long as the geometry does not interfere with the operative connection between the casing member (not illustrated) and the modular connector 46′.

It is to be noted that there are many potential variations in the modular connecting means that may be utilized in the modular coupling system of the present invention. Generally, any suitable means currently known in the relevant art or developed in the relevant art in the future may be used, as long as such means are used consistently in a manner that accommodates the connection of all of the modular connectors comprising the modular coupling system to all of the casing members comprising the modular coupling system. Thus, and referring to the device 15 illustrated in FIG. 1A through FIG. 1C as an example, the modular connectors (variable connecting members 30, 40) and the casing member 20 may have interacting portions of almost any shape or size, as long as the shape and size of such interacting portions cooperate to ensure that the modular connectors (such as variable connecting members 30, 40) of the system can be operatively connected to the casing member 20. For example, as illustrated in FIG. 8C, the adjusting member shell portion 146 (as an alternative embodiment of the adjusting member shell portion 46 of modular connector 40) of the modular connector 140 is comprised of a connector flange portion 146a that has a circular exterior edge and a connector shell portion 146b that has a hexagonal shape. The portions of the case body 121 that are adjacent to the open end 121a of the case body 121 and that bound at least a portion of the casing interior space 120a also have a hexagonal shape. Thus, the modular connector 140 is adapted to be positioned within the open end 121a of the case body 121. The case body 121 and the case cap (not illustrated) operate to connect the modular connector 140 to the casing member 120 (all acting as modular connecting means) in substantially the same manner as the case body 21 and case caps 22, 23 operatively connect the modular connectors (variable connecting members 30, 40) to the casing member 20, as described above and illustrated in connection with FIG. 1A through FIG. 1C. In other embodiments, as illustrated in FIG. 8D, modular connectors having other duct connecting means (which are described in more detail below), such as modular connector 140′ having a slip adapter 146c′, may have the same general shape. Similarly, any of the modular connectors 30, 40, 240, 250, 251, 352, 353, 454, 555, 656, 785, 857, 858, 959, 1050, 1051 illustrated in FIG. 1A through FIG. 18C may have the same type of shape so that they can be connected to the casing member 120. Referring again to FIG. 8D as an example, it is to be noted that this particular type of geometry (hexagonal shape) may be particularly advantageous for systems where ducts (not illustrated) will be screwed onto the modular connector 140, in that this shape prevents the modular connector 140′ from slipping rotationally within the casing member 120 while the duct (not illustrated) is being connected to the modular connector 140.

The device 915 illustrated in FIG. 17A through FIG. 17C illustrates another example of an alternative shape of modular connector 959 and casing member 920 that may comprise the modular connecting means. In this embodiment, the modular connector 959 is comprised of a connector flange portion 959a that is annular in shape, a connector shell portion 959b that has a beveled portion adjacent to the connector flange portion 959a and a cylindrical shaped portion extending from the beveled portion. The modular connector 959 is also comprised of a slip adapter portion 959c that extends from the connector flange portion 959a. The case body 921 and the case cap 922 also have corresponding surfaces (921a′ for the case body 921, but not illustrated for the case cap 922, but substantially the same as for case cap 22, as described above and illustrated in connection with FIG. 1A through FIG. 1C), respectively, that conform to the shape of the connector flange portion 959a and the connector shell portion 959b. In addition, the interior space adjacent to a portion of the open end 921a of the case body 921 has a ridge portion 959a″ that corresponds to a cut surface 959b′″ on the beveled portion of the connector shell portion 959b. This cooperating configuration prevents the modular connector 959 from slipping circumferentially within the casing member 920 while the duct (not illustrated) is being connected to the device 915. Thus, and referring again to the embodiment of the present invention illustrated in FIG. 1A through FIG. 1C as an example, the interfacing portions of the case body 21, the case caps 22, 23, and the modular connectors 30, 40 may also have approximately elliptical, triangular, square, rectangular, pentagonal, another polygonal shape, other shapes having arcuate or linear portions, or another shape or combination of such shapes, as long as such interfacing portions cooperate with one another to operatively connect the modular connectors 30, 40 to the casing member 20, all as described in more detail herein.

In addition, the modular connecting means may further comprise means to form a fluid-tight seal between the modular connectors 30, 40 and the casing member 20. For example, as illustrated in FIG. 1C through FIG. 3 and FIG. 9B, a washer 34, 45 may be positioned between the case body 21 and the modular connectors 30, 40, respectively. In some embodiments, the washer 34, 45 may be a part of the modular connector 30, 40, but this is not necessarily so in every embodiment. In the illustrated embodiment, the connector flange portion 30a, 40a is preferably positioned approximately within the open end 21a, 21d of the case body 21. By “approximately adjacent,” it is meant that the connector flange portion 30a, 40a is generally intended to be positioned adjacent to the open end 21a of the case body 21, but that other items, such as washers, o-rings or other members, may be positioned between the connector flange portion 30a, 40a and the open end 21a of the case body 21 in some embodiments. In the illustrated embodiment, the portion of the case cap 22 adjacent to the connector opening 22a is pressed against the connector flange portion 30a (including the washer 35) as the case cap 22 is screwed down onto the case body 21. This compression acts as a part of the modular connecting means to connect the variable connecting member 30 to the casing member 20, and also provides a fluid-tight seal between the variable connecting member 30 and the casing member 20. In other embodiments, the modular connecting means may comprise any suitable means for providing a fluid-tight seal between one or more portions of the modular connector 30 and one or more portions of the casing member 20, such as gaskets, o-rings, sealing compounds, and compression of the joining portions of the modular connector 30 and the casing member 20, or any other connecting or sealing means or a combination of such means. Where washers 35, gaskets or o-rings are utilized, they may be constructed of any suitable materials, such as rubber, synthetic rubber, or other polymers. Where a more permanent seal is preferred, the modular connecting means may be further comprised of an adhesive, adhesive tape, glue, epoxy, welding, fusing, or other similar means or a combination of such means, which may be used with or without a washer, gasket, o-ring or other similar means. Thus, as illustrated in FIG. 17A through FIG. 17B, the modular connector 959 may have an adhesive or adhesive tape 959b′ covered with a peel-off strip 959b″ positioned on a portion of the connector shell portion 959b. Prior to connection of the modular connector 959 to the casing member 920, the peel off strip 959b″ is removed, exposing the adhesive tape 959b′, which is then placed adjacent to the interfacing surface 921a′ of the case body 921. An example of such means is double coated urethane, vinyl or polyethylene adhesive tapes with release liners, such as those manufactured by the 3M Company. Alternatively, the user of the device 915 may place an adhesive (or an adhesive tape with or without peel-off strip) on one or more of the interfacing surfaces of the modular connector 959 and the case body 921 prior to connecting the modular connector 959 to the casing member 920. Referring again to the device 15 illustrated in FIG. 1A through FIG. 1C, the preferred modular connecting means are comprised of the modular connector 30 being held in place between the case cap 22 and the case body 21 in the manner illustrated in FIG. 1A through FIG. 1C and FIG. 9B. It is to be noted that the modular connecting means need not provide a fluid-tight seal in every embodiment of the present invention.

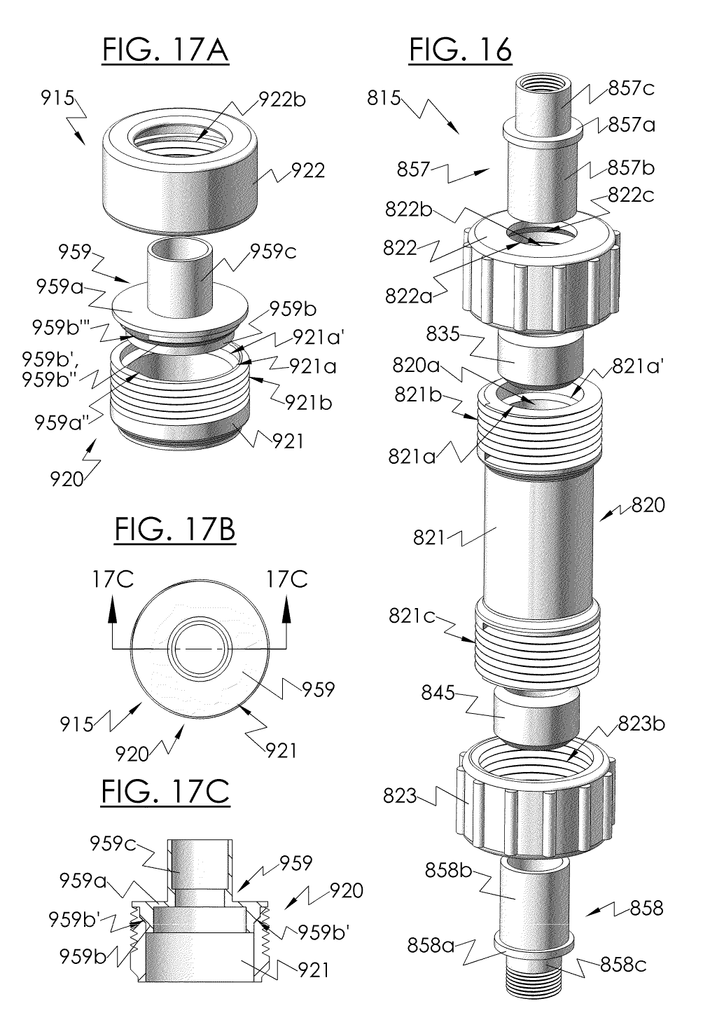

In still other embodiments of the present invention, the modular connecting means may be comprised of other types of connecting means. For example, as illustrated in FIG. 16, the device 815 may comprise modular connecting means that are comprised of a compression-type of connector. In this embodiment, the device 815 is generally comprised of a casing member 820 (which may including modular connecting means and compression members 835, 845 in this embodiment) and modular connectors 857, 858, which are described in more detail below. The casing member 820 is further comprised of a hollow, approximately tubular-shaped case body 821 and a case caps 822, 823 positioned at each end of the case body 821. Case cap 823 may have any of the characteristics, features, structure, functions and operation as case cap 822, as described in more detail below. The case cap 822 has a connector opening 822a positioned therein that is of a size and shape adapted to accommodate the modular connector 857. The case cap 822 may be removably or permanently connected to the case body 821 by case cap connecting means. Except for the particular modular connecting means described in more detail below, the casing member 820 may have any of the structures, features, characteristics, functions and operation as the casing members 20, 120, 220, 320, 420, 520, 620, 720, 820, 920, 1020 described above and illustrated in connection with FIG. 1A through FIG. 18C. In the case of a device 815 designed for use with room temperature domestic potable water and capable of accommodating ducts (not illustrated) in the range of ¾″ to ½″ nominal diameter, the case body 821 is preferably tubular in shape and is constructed of PVC. Preferably, the case cap 822 is generally of the shape illustrated in FIG. 16 and has a threaded case cap connecting means.

In the embodiment of the device 815 illustrated in FIG. 16, the compression member 835 is tubular in shape and is positioned between the case cap 822 and the case body 821. In other embodiments, the compression member 835 may have another shape, as long as the compression member 835 cooperates with the case cap 822, the modular connector 857, and the case body 821 to accommodate operation of the device 815, as described in more detail below. For example, the compression member 835 may generally have the shape of any type of ferrule that is used with various types of compression connectors, which are well known in the relevant art or that may be developed in the relevant art in the future. In addition, the compression member 835 may be comprised of any suitable type of material. For example, as is the case in the illustrated embodiment of the device 815, the compression member 835 may be comprised of rubber, synthetic rubber (including NEOPRENE), elastomers or other flexible, semi-rigid, or rigid polymers, or combinations of such materials, along with a combination that may including cloth, fabric or other materials. In other embodiments, the compression member 835 may be comprised of metal (such as steel, steel alloys, aluminum, copper, brass, or other metals or metal alloys), polymers (such as PVC, polyethylene, polypropylene, ABS, and other polymers), wood, fiberglass, carbon-based or other composites, or other materials or a combination of such materials. The compression member 835 may be fabricated using any suitable means. For example, a compression member 835 constructed of rubber may be formed by casting in a mold. In the case of a device 815 designed for use with room temperature domestic potable water and capable of accommodating ducts in the range of ¾″ to ½″ nominal diameter that utilizes a case body 821 constructed of PVC, the compression member 835 is preferably tubular in shape and is constructed of rubber or synthetic rubber.

In the embodiment of the device 815 illustrated in FIG. 16, the modular connecting means are comprised of the compression member 835, the modular connector 857, and the casing member 820 operating in a manner that utilizes compression between the casing member 820, the compression member 835, and the modular connector 857 in a manner adapted to form a fluid-tight seal between the casing member 820 and the modular connector 857. In the illustrated embodiment, a portion of the interior surface 821a′ of the case body 821 and a portion of the interior surface 822c of the case cap 822 located approximately adjacent to the case body open end 821a are adapted to be positioned adjacent to at least a portion of the exterior surface of the connector shell portion 857b of the modular connector 857. As the case cap 822 is screwed onto the case body 821, the interior surfaces 821a′, 822c of the case body 821 and the case cap 822 impinge against the exterior surface of the compression member 835, causing the compression member 835 to be compressed against the exterior surface of the connector shell portion 857b of the modular connector 857. This compression is adapted to form a fluid-tight seal between the compression member 835 and the modular connector 857 and between the compression member 835 and the case body 821 within the designed operating pressures of the device 815. The case cap 822 is typically screwed onto the case body 821 an extent that causes adequate compression to form the desired fluid-tight seal Thus, when fluid is present within the interior space 820a of the casing member 820, the interior space of the duct (not illustrated), and the interior space of the modular connector 857 (all of which are in fluid communication with one another), the fluid-tight connection between the casing member 820, the compression member 835, and the modular connector 857 hold the fluid within such interior spaces, so that the fluid does not escape through the spaces between the modular connector 857, the compression member 835, and the case body 821. It is to be noted that the modular connector 858 operates in cooperation with the casing member 821, the compression member 845, the case cap 823, and the case cap connecting means (threads 821c, 823b) in substantially the same manner as described above for modular connector 857, casing member 821, compression member 835, case cap 822, and case cap connecting means (threads 821b, 822b).

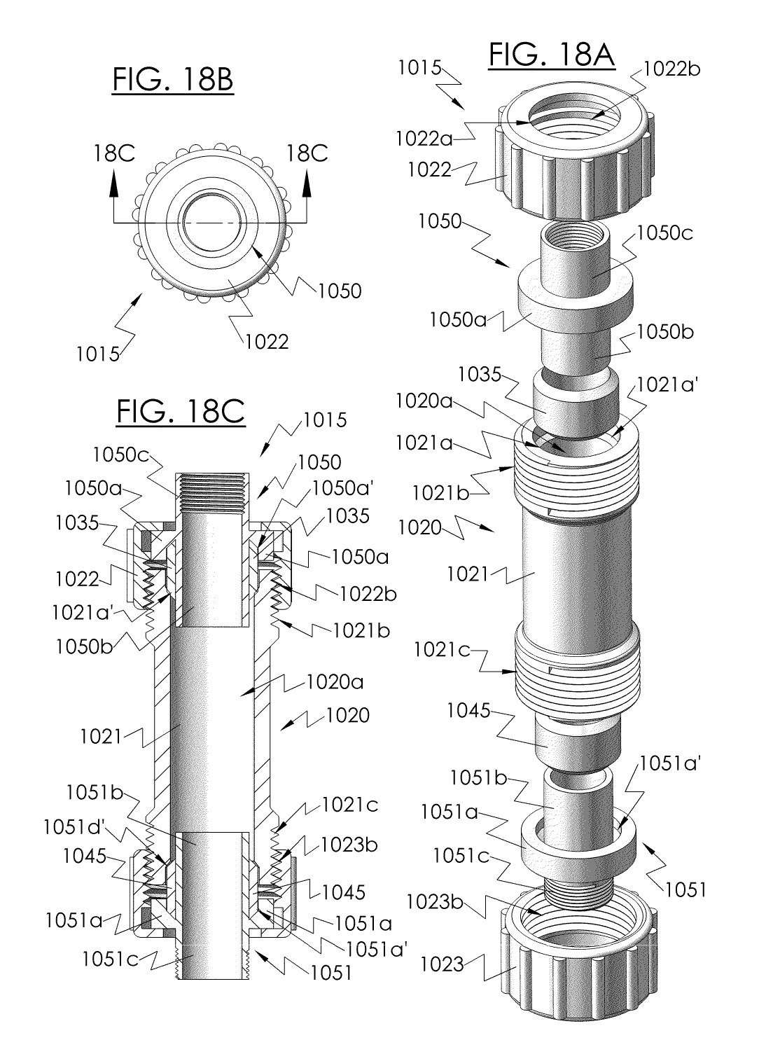

In various embodiments of the device 815, the modular connecting means of the device 815 may be comprised of almost any form of connector utilizing compression sealing means. Generally, this means may include any connecting means that involves a member being compressed against the exterior surface of a duct to form a fluid-tight seal between the connector and the duct. As an example of another type of such connector, the compression member 835 may be constructed as a part of the case cap 822 or the case body 821. In these cases, the fluid-tight seal may be created by compression of only a portion of the compression member 835 against the casing member 820 and the modular connector 857 because the portion of the compression member 835 that is attached to the casing member 820 is typically sealed by means other than compression. Another example of such modular connecting means is represented in the device 1015 illustrated in FIG. 18A through FIG. 18C. In this embodiment, the device 1015 is generally comprised of a casing member 1020 (including modular connecting means and compression members 1035, 1045 in this embodiment) and modular connectors 1050, 1051, which are described in more detail below. The casing member 1020 is further comprised of a hollow, approximately tubular-shaped case body 1021 and a case caps 1022, 1023 positioned at each end of the case body 1021. The case body 1021 may have substantially the same structure, features, characteristics, function and operation as the case body 821 described above and illustrated in connection with FIG. 16. Case cap 1023 may have any of the characteristics, features, structure, functions and operation as case cap 1022, as described in more detail below. The case cap 1022 has a connector opening 1022a positioned therein that is of a size and shape adapted to accommodate the modular connector 1050. The case cap 1022 is approximately cylindrical in shape and may be permanently or removably attached to the open end 1021a of the case body 1021 adjacent to the case cap 1022 by the case cap connecting means, which are described in more detail below. Except for the specific differences in modular connecting means described below, the case cap 1022 may have substantially the same structure, features, characteristics, function and operation as the case cap 822 described above and illustrated in connection with FIG. 16.

In the embodiment of the device 1015 illustrated in FIG. 18A through FIG. 18C, the compression member 1035 is tubular in shape and is positioned between the modular connector 1050 and the case body 1021. In other embodiments, the compression member 1035 may have another shape, as long as the compression member 1035 cooperates with the case cap 1022, the modular connector 1050, and the case body 1021 to accommodate operation of the device 1015, as described in more detail below. For example, the compression member 1035 may have substantially the same structure, features, characteristics, function and operation as the compression member 835 described above and illustrated in connection with FIG. 16. In the embodiment of the device 1015 illustrated in FIG. 18A through FIG. 18C, the modular connecting means are comprised of the compression member 1035, the modular connector 1050, and the casing member 1020 operating in a manner that utilizes compression between the casing member 1020, the compression member 1035, and the modular connector 1050 in a manner adapted to form a fluid-tight seal between the casing member 1020, the compression member 1035, and the modular connector 1050. In the illustrated embodiment, the modular connector 1050 is comprised of a connector flange portion 1050a, as well as a connector shell portion 1050b and a connector slip adapter 1050c that both extend from the connector flange portion 1050a in opposite directions. The connector flange portion 1050a has a hollow portion bounded by an interior surface 1050a′. The hollow portion is of a size and shape so that the interior surface 1050a′ of the hollow portion is positioned approximately adjacent to a portion of the exterior surface of the compression member 1035. By “approximately adjacent,” it is meant that there may be a small amount of space between the interior surface 1050a′ of the hollow portion of the connector flange portion 1050a and the exterior surface of the compression member 1050a, but not so much space that the operation of the device 1015, as described in more detail below, is unduly hampered. In addition, a portion of the surface 1021a′ of the case body 1021 located approximately adjacent to the case body open end 1021a is adapted to be positioned approximately adjacent to at least a portion of the exterior surface of the compression member 1035. Further, a portion of the case cap 1022 adjacent to the connector opening 1022a is adapted to be positioned against the surface of the connector flange portion 1050a that is opposite the hollow portion of the connector flange portion 1050a.

As the case cap 1022 is screwed onto the case body 1021, the interior surface 1021a′ of the case body 1021 and the interior surface 1050a′ of the hollow portion of the connector flange portion 1050a impinge against the exterior surface of the compression member 1035, causing the compression member 1035 to be compressed against the exterior surface of the connector shell portion 857b and the interior surface 1050a′ of the modular connector 1050. This compression is adapted to form a fluid-tight seal between the compression member 1035 and the modular connector 1050 and between the compression member 1035 and the case body 1021 within the designed operating pressures of the device 1015. The compression of the case cap 1022 against the modular connector 1050 holds the modular connector 1050 and the compression member 1035 in place relative to the case body 1021. The case cap 1022 is typically screwed onto the case body 1021 an extent that causes adequate compression to form the desired fluid-tight seal Thus, when fluid is present within the interior space 1020a of the casing member 1020, the interior space of the duct (not illustrated), and the interior space of the modular connector 1050 (all of which are in fluid communication with one another), the fluid-tight connection between the casing member 1020, the compression member 1035, and the modular connector 1050 hold the fluid within such interior spaces, so that the fluid does not escape through the spaces between the modular connector 1050, the compression member 1035, and the case body 1021. It is to be noted that the modular connector 1051 operates in cooperation with the casing member 1021, the compression member 1045, the case cap 1023, and the case cap connecting means (threads 1021c, 1023b) in substantially the same manner as described above for modular connector 1050, casing member 1021, compression member 1035, case cap 1022, and case cap connecting means (threads 1021b, 1022b).

In the embodiments of the devices 815, 1015 illustrated in FIG. 16 and FIG. 18A through FIG. 18C, the casing members 820, 1020 are generally in the configuration of a coupling, so that they can accommodate connection to two ducts (not illustrated) simultaneously. In other embodiments, the casing members 820, 1020 may be incorporated in a variety of ways in any standard types of fittings, as is the case with casing members 20, 120, 220, 320, 420, 520, 620, 720, 920 described above and illustrated in connection with FIG. 1A through FIG. 15C. In addition, from the preceding description of the modular connecting means, it should be apparent to a person of reasonable skill in the relevant art that almost any connecting, coupling and joining means may be incorporated as a part of the modular connecting means of the present invention. For example, in addition to the embodiments of the modular connecting means described herein, the modular connecting means may be comprised of any type of threaded connector, luer lock fittings, SWAGELOK® fittings, quick connect/disconnect fittings, hose barbs, stepped tubing connectors, compression fittings and connectors, tubing and hose connectors, SPEEDFIT® connectors, couplings for connection using clamps or adhesives, or other connecting means or a combination of such means. All of such fittings and connecting, coupling and joining systems may be included as modular connecting means within the spirit and scope of the invention as defined by the appended claims.

Referring to the device 15 illustrated in FIG. 1A through FIG. 9B as an example, the modular connectors 30, 40 are generally comprised of modular connecting means (as described above and illustrated in connection with FIG. 1A through FIG. 18C) and duct connecting means (which are described in more detail below). The modular connectors 30, 40 may be comprised of any suitable materials. For example, the modular connectors 30, 40 may be comprised of metal (such as steel, steel alloys, aluminum, copper, brass, or other metals or metal alloys), polymers (such as PVC, polyethylene, polypropylene, ABS, and other polymers), wood, fiberglass, carbon-based or other composites, or other materials or a combination of such materials. The preferred material is dependent upon a number of different factors, such as the anticipated size, shape and type of the ducts (pipes 70, 75), the type of connection (duct connecting means) to be made to the ducts (pipes 70, 75), the size, shape, material composition and configuration of the casing member 20, the anticipated operating pressures of the device 15, the anticipated operating or installation temperatures of the device 15, the type of fluid carried by the ducts (pipes 70, 75), the preferences of the user of the device 15, and other factors. It is to be noted that the modular connectors 30, 40 may be constructed of the same materials as the casing member 20, but this need not be the case for all embodiments. For example, the casing member 20 may be comprised of PVC, while the modular connectors 30, 40 may be comprised of several different materials (as described in more detail below and illustrated in connection with FIG. 2 through FIG. 8C). In addition, the modular connectors 30, 40 comprising a modular coupling system do not all need to be constructed of the same materials. For example, the modular connectors 30, 40 may be comprised of several different materials (as described in more detail below and illustrated in connection with FIG. 2 through FIG. 8C), while the modular connector 250 illustrated in FIG. 10A and FIG. 10B may be comprised of copper and the modular connector 251 illustrated in FIG. 11 may be comprised of PVC. Thus, even if the casing members 20, 220 illustrated in FIG. 1A through FIG. 1C and FIG. 9A through FIG. 10A are constructed of PVC and are comprised of a common modular connecting means (so that they are part of the same modular coupling system), the modular connectors 30, 40, 250, 251 may each be comprised of any of the materials specified above. This provides flexibility in the coupling system. For example, if the user of the device 215 illustrated in FIG. 10A desires to connect a steel pipe (not illustrated) to a copper pipe (not illustrated), the user may utilize an MIP modular connector 250 to connect to the steel pipe and use a slip modular connector 251, such as that illustrated in FIG. 11, at the other end of the casing member 220 (instead of the illustrated variable connecting modular connector 240 illustrated) to connect to the copper pipe. If the casing member 220 is constructed of PVC, the MIP modular connector 250 is constructed of steel, and the slip modular connector 251 is constructed of copper, the connection between the steel pipe and the copper pipe will have a dielectric effect, preventing corrosive electrical current flow between the steel pipe and the copper pipe. In addition, the slip modular connector 251 constructed of copper would allow the modular connector 251 to be soldered to the copper pipe first, followed by connection of the slip modular connector 251 to the PVC casing member 220 so that the casing member 220 wouldn't be melted during the soldering process. (In this case, the case cap 223 would be placed over the copper pipe and positioned away from the end of the pipe prior to and during the soldering process to prevent the case cap 223 from melting.) Further still, each of the modular connectors 30, 40 may be comprised of several different materials (as described in more detail below and illustrated in connection with FIG. 2 through FIG. 8C). As another example, the modular connector 250 illustrated in FIG. 10A and FIG. 10B may have its MIP adapter portion 250c comprised of copper, while the connector flange portion 250a and the connector shell portion 250b are comprised of a polymer, such as ABS. Referring to FIG. 10A through FIG. 11 as an example, the modular connectors 250, 251 may be fabricated using any suitable means. For example, a modular connector 250, 251 constructed of PVC may be formed by injection molding and a modular connector 250, 251 constructed of a metal alloy may be formed by metal injection molding. Where the modular connector 250, 251 is constructed of more than one material, the various components comprising the modular connector 250, 251 may be assembled using glue, adhesive, adhesive tape, epoxy, welding, fusing, clamps, screws, nuts and bolts, or other fastening means or a combination of such means. The modular connectors 30, 40, which are comprised of several different materials, may be constructed in the manner described in more detail below and illustrated in connection with FIG. 2 through FIG. 8C.

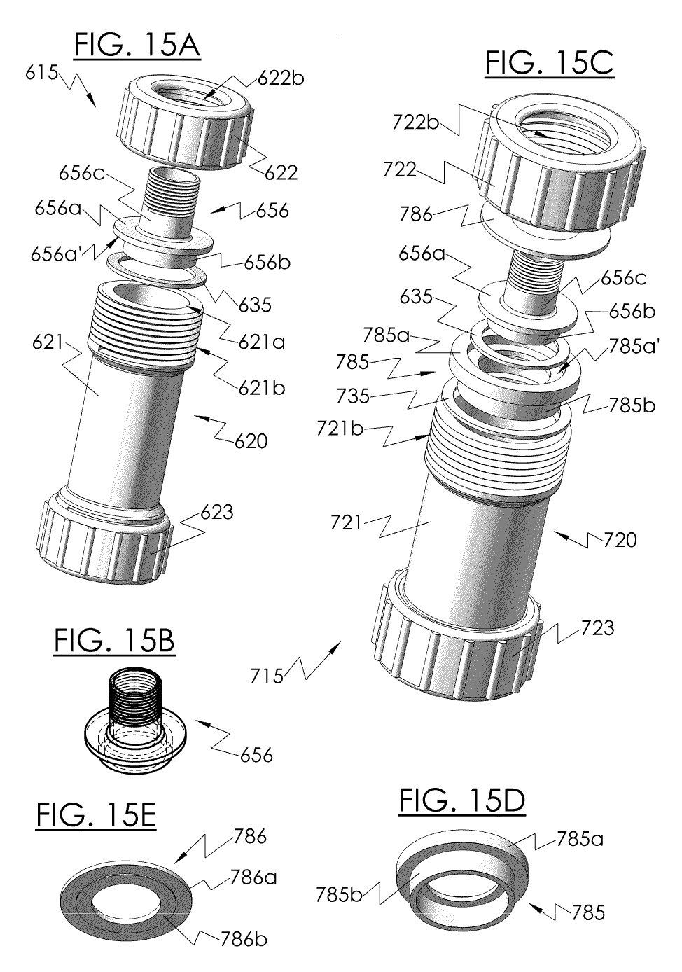

Referring again to the device 15 illustrated in FIG. 1A through FIG. 9B as an example, each of the modular connectors 30, 40 may have almost any shape, as long as the shape cooperates with the casing member 20 to accomplish the connection of the modular connectors 30, 40 to the casing member 20 using the modular connecting means. The shape of the modular connectors 30, 40 also typically cooperates with the duct connecting means (described in more detail below) to accomplish connection of the modular connectors 30, 40 to the ducts (pipes 70, 75). Thus, the modular connectors 30, 40 may have a cross-section or other dimensional perspective that is approximately elliptical, triangular, square, rectangular, pentagonal, hexagonal, another polygonal shape, a shape having linear or curved sections (or both), or another shape or a combination of such shapes. In addition, each of the modular connectors 30, 40 may be comprised of duct connecting means. For example, as is the case with the modular connectors 30, 40, one or more of the modular connectors comprising the modular coupling system may be further comprised of variable connecting means, which are described in more detail below and illustrated in connection with FIG. 1A through FIG. 9B. As another example, as illustrated in FIG. 10A, FIG. 10B, FIG. 15A, FIG. 15B, FIG. 16, and FIG. 18A through FIG. 18C, the duct connecting means may be comprised of an MIP adapter portion 250c, 656c, 858c, 1051c of the modular connector 250, 656, 858, 1051, respectively. This type of modular connector 250, 656, 858, 1051 may typically be used to connect to any duct, device, fitting (such as a coupling, elbow, or tee) or other object (not illustrated) having a corresponding threaded FIP connection. As yet another example, as illustrated in FIG. 8D, FIG. 11, and FIG. 17A through FIG. 17C, the duct connecting means may be comprised of a slip adapter portion 140c′, 251c, 959c of the modular connector 140′, 251, 959, respectively. This type of modular connector 140, 251, 959 may typically be used to connect to any duct, device, fitting (such as a coupling, elbow, or tee) or other object (not illustrated) having a corresponding non-threaded connection. Alternatively, the slip adapter portion 140c′, 251c, 959c of the modular connector 140′, 251, 959, respectively, may be comprised of the duct end portion of the connecting means, rather than the hub portion of the connecting means. As still another example, as illustrated in FIG. 16 and FIG. 18A through FIG. 18C, the duct connecting means may be comprised of an FIP adapter portion 857c, 1050c of the modular connector 857, 1050, respectively. This type of modular connector 857, 1050 may typically be used to connect to any duct, device, fitting (such as a coupling, elbow, or tee) or other object (not illustrated) having a corresponding threaded MIP connection. Referring again to the device 15 illustrated in FIG. 1A through FIG. 9B as an example, the duct connecting means may not always serve to connect the modular connectors 30, 40 to a duct. For example, in various embodiments, the duct connecting means may comprise a plug or cap (not illustrated), so that the modular connector 30, 40 seals off the open end 21a, 22a, 21d, 23a of the casing member 20 to which it is connected.

As a further example, as illustrated in FIG. 12A through FIG. 12C, the duct connecting means may be comprised of an adapter fitting 353c that is adapted to be connected to more than one duct (not illustrated). In the illustrated embodiment, the adapter fitting 353c is comprised of an adapting tee, which is connected to the connector flange portion 353a at one end, has a slip adapter portion 353c′ at another end, and has an MIP adapter portion 353c″ at the third end. Thus, this type of modular connector 353 may typically be used to connect to any one duct, device, fitting (such as a coupling, elbow, or tee) or other object (not illustrated) having a corresponding non-threaded connection and a second duct, device, fitting (such as a coupling, elbow, or tee) or other object (not illustrated) having a corresponding threaded FIP connection. It is to be noted that the duct connecting means (adapter fitting 353c) of the modular connector 353 may comprise any of the duct connecting means described herein. The duct connecting means (adapter fitting 353c) may comprise any one of such means, or any combination of such means, as is the case with the tee-shaped adapter fitting 353c. In addition, the modular connector 353 may take the form of any standard type of fitting in a manner similar to the casing members 20, 120, 220, 320, 420, 520, 620, 720, 920, 1020 comprising the modular coupling system, as described above and illustrated in connection with FIG. 1A through FIG. 18C. For example, and referring again to FIG. 12A through FIG. 12C, the modular connector 353 may take the form of an elbow or a cross. In these embodiments, portions of the modular connector 353 may be fabricated using any appropriate means (such as injection molding or metal injection molding), and the portions may then be assembled using any appropriate means, such as glue, adhesive, adhesive tape, epoxy, welding, fusing, clamps, screws, nuts and bolts, or other fastening means or a combination of such means. In such cases, the case cap 323 may be assembled as a part of the modular connector 353, which may entail positioning the case cap 323 on a portion of the modular connector 353 before the various portions are assembled.

Yet another example of duct connecting means is illustrated in the device 415 of FIG. 13A through FIG. 13C. In this embodiment, the duct connecting means of the modular connector 454 are generally comprised of a connector flange portion 454a′ and a connector shell portion 454b′, which are substantially the same as the connector flange portion 454a and connector shell portion 454b comprising the modular connecting means that are used to connect the modular connector 454 to the casing member 420. Because the duct connecting means and the modular connecting means of the modular connector 454 are operatively the same, the duct connecting means may be used to connect the modular connector 454 to another casing member 420′ of the modular coupling system. Thus, the modular connector 454 acts as a casing connector, so that casing members 420, 420′ comprising the modular coupling system may be connected to one another as desired by the user of the device 415. It is to be noted that the duct connecting means and the modular connecting means of the modular connector 454 may comprise any of the modular connecting means described above and illustrated in connection with FIG. 1A through FIG. 18C. In addition, the length of the segment 454c between the two means may be of varying lengths, as desired by the user of the device 415. Further, the modular connector 454 may take the form of any standard type of fitting in a manner similar to the casing members 20, 120, 220, 320, 420, 520, 620, 720, 920, 1020 comprising the modular coupling system, as described above and illustrated in connection with FIG. 1A through FIG. 18C. For example, and referring again to FIG. 13A through FIG. 13C, the modular connector 454 may take the form of an elbow (so that casing members 420, 420′ can be connected at a 90 degree angle) or a tee (so that three casing members 420, 420′ can be connected together).

Another embodiment of a casing connector (such as modular connector 454) is illustrated in FIG. 14A and FIG. 14B. In this embodiment, the modular connector 555 is comprised of modular connecting means (a connector flange portion 555a and a connector shell portion 555b) that are adapted to connect the modular connector 555 to the casing member 520. The modular connector 555 is also comprised of duct connecting means (a connector flange portion 454a′ and a connector shell portion 454b′), which also act as modular connecting means to connect the modular connector 555 to another casing member 520′. In this embodiment, however, the duct connecting means (connector flange portion 454a′ and connector shell portion 454b′) are not the same as the modular connecting means (connector flange portion 555a and connector shell portion 555b). Instead, the duct connecting means (connector flange portion 454a′ and connector shell portion 454b′) act as modular connecting means to connect the modular connector 555 to a casing member 520′ having a modular connecting means different from that comprising casing member 520. Thus, the modular connector 555 acts as an adjusting casing connector that serves to connect a casing member 520 having one modular connecting means to a casing member 520′ having a different modular connecting means. In the illustrated embodiment, the casing member 520′ has the same general type of modular connecting means as the casing member 520, but casing member 520′ is generally smaller than the casing member 520. Casing members 520, 520′ of this type may be utilized where one system (of which casing member 520 is a part) is used to connect to a relatively large size of duct (such as 1¼″ to 2″ diameter pipe) and the other system (of which casing member 520′ is a part) is used to connect to a relatively small size of duct (such as ½″ to 1″ diameter pipe). The adjusting casing connector (modular connector 555) may be used to join casing members 520, 520′ of these two systems together. Although the adjusting casing connector (modular connector 555) may be used to join casing members 520, 520′ having different sizes of modular connecting means in some embodiments, the duct connecting means (and its corresponding modular connecting means) of the modular connector 555 may also comprise any of the modular connecting means described above and illustrated in connection with FIG. 1A through FIG. 18C. For example, in other embodiments, the duct connecting means (connector flange portion 555a′ and connector shell portion 555b′) may have substantially the same size and shape as the hexagonal modular connecting means of the modular connectors 140, 140′ illustrated in FIG. 8C and FIG. 8D. In this embodiment, the adapting casing connector (modular connector 555) would be able to connect the casing member 520 to the casing members 120, 120′. In addition, the length of the segment 555c between the two means may be of varying lengths, as desired by the user of the device 515. Further, the adjusting casing connector (modular connector 555) may take the form of any standard type of fitting in a manner similar to the casing connector 454 described above and illustrated in connection with FIG. 13A through FIG. 13C. For example, and referring again to FIG. 14A and FIG. 14B, the modular connector 555 may take the form of an elbow (so that casing members 520, 520′ can be connected at a 90 degree angle) or a tee (so that three casing members 520, 520′ can be connected together).

In embodiments of the present invention where the modular coupling system is comprised of casing members 620, 720 having two different sizes or types of modular connecting means, as is illustrated in FIG. 15A through FIG. 15E, it may be desirable to use modular connectors (such as modular connector 656) adapted to be used with one casing member (such as casing member 620) with casing members (such as casing member 720) of the different size or type. In such cases, the modular connector 656 may not typically be used directly with the casing member 720 because they each have a different modular connecting means. In such circumstances, an adjusting modular connector 785, 786 may be used to adapt the modular connector 656 for use with the casing member 720. In the illustrated embodiment, the adjusting modular connector 785, 786 is comprised of an adapter body 785 and an adapter compression plate 786. The adapter body 785 is further comprised of an adapter body flange portion 785a and an adapter body shell portion 785b, the exterior surfaces of which are adapted to connect to the casing member 720 as a part of the modular connecting means comprising casing member 720. In the illustrated embodiment, a washer 735 is positioned between the case body 721 and the adapter body 785 in order to form a fluid-tight seal between the case body 721 and the adapter body 785. In other embodiments, an adhesive, adhesive tape, glue, epoxy or other fastening means or a combination of such means may be used to form or enhance the fluid-tight seal or to hold the adapter body 785 in place in the casing member 720 or both. It is not, however, necessary to have a fluid-tight seal in all embodiments. The interior surfaces of the adapter body 785 (adapter body flange portion 785a and the adapter body shell portion 785b) are adapted to have a modular connecting means that are operatively the same as that comprising the casing member 620. Thus, a portion (generally the connector flange portion 656a and the connector shell portion 656b in this embodiment) of the modular connector 656 may be positioned within the interior of the adapter body 785 in substantially the same manner as the modular connector 656 may be positioned within the open end 621a of the case body 621 of casing member 620. In the illustrated embodiment, a washer 635 is positioned between the modular connector 656 and the adapter body 785 in order to form a fluid-tight seal between the modular connector 656 and the adapter body 785. In other embodiments, an adhesive, adhesive tape, glue, epoxy or other fastening means or a combination of such means may be used to form or enhance the fluid-tight seal or to hold the modular connector 656 in place in the adapter body 785 or both. It is not, however, necessary to have a fluid-tight seal in all embodiments. The compression plate 786, which is comprised of a plate flange portion 786a and a plate shell portion 786b in this embodiment, is positioned between the adapter body 785 and the connector flange portion 656c of the modular connector 656, on the one hand, and the case cap 722, on the other hand. The compression plate 786 is adapted to interface with the case cap 722 and the case body 721 as a part of the modular connecting means comprising the casing member 720. As the case cap 722 is screwed down onto the case body 721, the compression plate 786 is compressed against the adapter body 785 and the connector flange portion 656c of the modular connector 656, which are also compressed against the case body 721, holding all such components operatively in place relative to one another. The plate shell portion 876b of the compression plate 786 is raised above the plate flange portion 786a so that the plate shell portion 786b is adapted to exert an even greater pressure against the connector flange portion 656a, preferably enhancing the fluid-tight seal between the modular connector 656 and the adapter body 785. Although the illustrated configuration of the adjusting modular connector 785, 786 is the preferred configuration, the adjusting modular connector 785, 786 may have another configuration in other embodiments. For example, the adjusting modular connector 785, 786 may be comprised of any of the different sizes or types of modular connecting means and duct connecting means described above and illustrated in connection with FIG. 1A through FIG. 18C. For example, in other embodiments, the adjusting modular connector 785, 786 may have substantially the same size and shape as the hexagonal modular connecting means of the modular connectors 140, 140′ illustrated in FIG. 8C and FIG. 8D as its modular connecting means to connect to the casing member 720, while its interior surfaces accommodate modular connectors 656 of the type illustrated in FIG. 15A and FIG. 15B. In addition, the adjusting modular connector 785, 786 may be of almost any shape, as long as it is adapted to connect the casing member 720 to the adjusting modular connector 785, 786 using the appropriate first modular connecting means and to connect the modular connector 656 to the adjusting modular connector 785, 786 using the appropriate second modular connecting means. For example, the adapter body flange portion 785a or the adapter body shell portion 785b or both may be longer than as illustrated. As another example, the compression plate 786 may not comprise a plate shell portion 786b or may comprise a plate shell portion 786b of greater thickness.

In addition, from the preceding description of the modular connectors, and the following description of the variable connecting means that may comprise modular connectors, it should be apparent to a person of reasonable skill in the relevant art that almost any connecting, coupling and joining means may be incorporated as a part of the duct connecting means of the present invention. For example, in addition to the embodiments of the duct connecting means described herein, the duct connecting means may be comprised of any type of threaded connector, duct, luer lock fittings, SWAGELOK® fittings, quick connect/disconnect fittings, hose barbs, stepped tubing connectors, compression fittings and connectors, tubing and hose connectors, SPEEDFIT® connectors, welding or fusion connections, couplings for connection using clamps or adhesives, or other connecting means or a combination of such means. All of such fittings and connecting, coupling and joining systems may be included as duct connecting means within the spirit and scope of the invention as defined by the appended claims.

The variable connecting means of the modular connectors 30, 40 illustrated in FIG. 1A through FIG. 9B represent yet another example of duct connecting means. Generally, the variable connecting means comprising any of the modular connectors 30, 40, 240 of the present invention may include any of the aspects, features, characteristics, structures, functions and operations of any of the inventions disclosed in U.S. Nonprovisional patent application Ser. No. 11/522,607 filed on Sep. 18, 2006, Ser. No. 11/879,346 filed on Jul. 17, 2007, Ser. No. 12/012,954 entitled DUCT COUPLING ADJUSTMENT AND THRUST LOAD RESTRAINT SYSTEM, filed on Feb. 6, 2008, and U.S. Provisional Patent Application No. 61/062,428 filed on Jan. 25, 2008, which also name as inventor the inventor of the present invention. The entire disclosure of each of these patent applications is incorporated herein by this reference. Considering variable connecting member 30 as an example for purposes of the present invention, the variable connecting member 30 (as an embodiment of the variable connecting means) of the device 15 is positioned approximately within the open end 21a of the case body 21. By positioning “approximately within the case body open end 21a,” it is meant that the variable connecting member 30 is generally intended to be positioned adjacent to and within the space bounded by the portion of the case body 21 adjacent to the case body open end 21a, but that in some embodiments the variable connecting member 30 may be positioned slightly above or below such case body adjacent portion or that there may be other members, such as variable member connecting means (washer 35 in the illustrated embodiment), also placed in the case body open end 21a so that the variable connecting member 30 may be slightly displaced from the case body open end 21a. As described in more detail below, the end of the duct (pipe 70) is inserted into the device 15, so that the duct (pipes 70) extends into the variable connecting member 30 as well. In the embodiment of the device 15 illustrated in FIG. 3, the variable connecting means are generally comprised of duct sealing means, seal support means, variable member connecting means (comprising washer 35 in this embodiment), and supplemental duct sealing means, all of which are described in more detail below.

In the embodiment of the device 15 illustrated in FIG. 2 through FIG. 4B, FIG. 5A, and FIG. 5B, the duct sealing means are generally comprised of a hollow internal seal member 32 and a hollow external seal member 33. In the embodiment illustrated in FIG. 5A, the internal seal member 32 is comprised of an internal seal flange portion 32a adjacent to an internal seal inlet 32e and an internal seal sheath portion 32b that extends from the internal seal flange portion 32a. The internal seal sheath portion 32b is further comprised of an internal seal interior surface 32c and an internal seal exterior surface 32d, which are bounded by the internal seal inlet 32e and an internal seal outlet 32f. The internal seal sheath portion 32b also has an internal seal slit 32g that runs from the interior seal outlet 32f along the internal seal sheath portion 32b a portion of the way toward the interior seal inlet 32e. The portions 32b′ of the internal seal sheath portion 32b adjacent to the internal seal slit 32g are generally tapered so that the thickness of the internal seal sheath portion 32b is gradually reduced to zero thickness at the internal seal slit 32g. In this embodiment of the device 15, as illustrated in FIG. 6, the external seal member 33 is comprised of an external seal flange portion 33a adjacent to an internal seal inlet 33e and an external seal sheath portion 33b extending from the external seal flange portion 33a. The external seal sheath portion 33b is further comprised of an external seal interior surface 33c and an external seal exterior surface 33d, which are bounded by the external seal inlet 33e and an external seal outlet 33f. The external seal sheath portion 33b also has an external seal slit 33g that runs from the external seal outlet 33f along the external seal sheath portion 33b a portion of the way toward the external seal inlet 33e. The portions 33b′ of the external seal sheath portion 33b adjacent to the external seal slit 33g are generally tapered so that the thickness of the external seal sheath portion 33b is gradually reduced to zero thickness at the external seal slit 33g.

In this embodiment, the internal seal member 32 is positioned within the external seal member 33, as is best illustrated in FIG. 2 and FIG. 9B, so that the internal seal exterior surface 32d faces and may be adjacent to the external seal interior surface 33c. The internal seal flange portion 32a is also positioned adjacent to the external seal flange portion 33a and the two are operatively connected by the seal connecting means. Preferably, the seal connecting means connect the internal seal flange portion 32a and the external seal flange portion 33a, as portions of the internal seal member 32 adjacent to the internal seal inlet 32e and of the external seal member 33 adjacent to the external seal inlet 33e, respectively, in a manner that forms a fluid-tight seal between them. This fluid-tight seal (and the seal connecting means generally) may be formed by compression of the internal seal flange portion 32a against the external seal flange portion 33a or by use of other suitable means, such as adhesive, adhesive tape, glue, epoxy, welding, fusing, clasps, clamps, fasteners or other suitable attachment means or a combination of such means, in each case as applied to all or a portion of the internal seal flange portion 32a or the external seal flange portion 33a or both. In addition, the internal seal slit 32g is preferably positioned so that it is on approximately the opposite side of the duct sealing means from the external seal slit 33g, as is best illustrated in FIG. 2. Further, the duct sealing means (internal seal member 32 and external seal member 33) are generally constructed in whole or in part of materials that permit them to expand to conform to the exterior surface of the largest size of duct (adjacent to the end of pipe 70) that may be connected to the device 15, while still maintaining the structural integrity of the internal seal member 32 and the external seal member 33 during operation of the device 15. In addition, the materials are preferably compatible with the type of fluid anticipated in the interior space 70b of the duct (pipes 70). For example, the internal seal member 32 and the external seal member 33 may each be comprised of any suitable elastic material, such as rubber, synthetic rubber (including NEOPRENE), elastomers or other elastic polymers, or combinations of such materials, along with a combination that may including cloth, fabric or other flexible or semi-flexible materials. It is to be noted, however, that the internal seal member 32 and the external seal member 33 need not be constructed entirely of flexible or elastic materials. For example, the internal seal flange portion 32a and the external seal flange portion 33a, or a portion of the internal seal sheath portion 32b and the external seal sheath portion 33b adjacent to the internal seal flange portion 32a and the external seal flange portion 33a, respectively, or any combination thereof, may be comprised of a rigid or semi-rigid material, such as wood, ceramic, metal, fiberglass, carbon-based or other composites, rigid or semi-rigid polymers (such as polyvinyl chloride and polycarbonate), or other rigid or semi-rigid materials or a combination of such materials. This may assist in facilitating a fluid-tight seal between the internal seal flange portion 32a and the external seal flange portion 33a and the case body 21 in some embodiments.

Thus, as the duct (pipe 70) is inserted into the internal seal member 32 and the external seal member 33, the internal sheath member 32b and the external sheath member 33b change shape to conform to the shape of the exterior surface of the duct (pipe 70) at the end thereof so that it fits tightly against the exterior surface of the duct (pipe 70). In order to accommodate a larger size of duct (pipe 70), the internal seal sheath portion 32b and the external seal sheath portion 33b may also expand radially in a manner that causes the internal seal exterior surface 32d to slide circumferentially along the external seal interior surface 33c. As this expansion occurs, the internal seal slit 32g and the external seal slit 33g may also increase in size. Because the internal seal slit 32g and the external seal slit 33g are on approximately opposite sides, the seal slits 32g, 33g do not overlap as they widen, so that portions of the internal seal sheath portion 32b and the external seal sheath portion 33c are positioned adjacent to the duct (pipe 70) around the duct's (pipe 70) entire circumference. This preferably forms a fluid-tight seal between the exterior surface of the duct (pipe 70) and portions of the internal seal member 32 and the external seal member 33, creating the fluid-tight chamber 50, as illustrated and described in more detail elsewhere herein in connection with FIG. 9B. It is to be noted that the duct sealing means (internal seal member 32 or external seal member 33 or both in the illustrated embodiment) may have a different configuration in other embodiments. For example, as illustrated in FIG. 5B, the internal seal member 132 may not have a slit. Similarly, the external seal member 33 illustrated in FIG. 6 may not have a slit, in which case it would have an appearance similar to that of the internal seal member 132 illustrated in FIG. 5B. Alternatively, both the internal seal members 32 and the external seal member 33 may not have a slit. In other embodiments, either or both slits 32g, 33g may have a different shape. For example, either or both of the slits 32g, 33g may be longer or shorter or may have a curved shape. As yet another example, the portion of the internal seal sheath portion 32b or the external seal sheath portion 33b or both adjacent to the slits 32g, 33g, respectively, may not be tapered. As still another example, the placement of the slits 32g, 33g relative to one another may be different (i.e., they may not be placed on opposite sides). Further, there may be more than one slit 32g, 33g in either or both of the internal seal member 32 and the external seal member 33, respectively. Further still, although it is preferable that the internal seal sheath portion 32b and the external seal sheath portion 33b are not attached to one another so that they can move relative to one another, in some embodiments they may be attached at one or more portions thereof. In yet other embodiments, the internal seal sheath portion 32b and the external seal sheath portion 33b may not be positioned adjacent to one another over their entire facing surfaces 32d, 33c. In yet other embodiments, the internal seal member 32 and the external seal member 33 may be fabricated together as a single component.

The internal seal member 32 and the external seal member 33 may be constructed using any suitable means. For example, internal seal members 32 and the external seal members 33 constructed entirely of synthetic rubber may be cast in a mold. As another example, an internal seal member 32 and an external seal member 33 comprised of one or more materials may have various components assembled utilizing adhesives, welding, fusing or any other suitable means. Further, the seal connecting means are utilized in connecting the internal seal member 32 and the external seal member 33, as described in more detail above. Preferably, for devices 15 utilizing the internal support structure 31 and the external support structure 34 of the illustrated embodiment and designed for use with tubular ducts (pipe 70) having a nominal diameter in the range of ½″ to ¾″ carrying potable water for domestic use, the internal seal member 32 and the external seal member 33 have the configuration illustrated in FIG. 5A through FIG. 6 and are constructed entirely of NEOPRENE having a thickness in the range of 1/16 inch to ⅛ inch. It is also to be noted that in various embodiments of the present invention, the duct sealing means may have any structure, characteristics, features, functions, and operation disclosed for the sealing member and its ancillary members in U.S. patent application Ser. No. 11/879,346 filed on Jul. 17, 2007, disclosed for the duct sealing means in U.S. patent application Ser. No. 12/012,954 entitled DUCT COUPLING ADJUSTMENT AND THRUST LOAD RESTRAINT SYSTEM, filed on Feb. 6, 2008, and disclosed for the duct sealing means in U.S. Provisional Patent Application No. 61/062,428 filed on Jan. 25, 2008. The full disclosure of each of these patent applications is incorporated herein by this reference.

In the embodiment of the device 15 illustrated in FIG. 1A through FIG. 9B, and as best illustrated in FIG. 2, FIG. 4, FIG. 7A through FIG. 7C, and FIG. 9B, the seal support means are generally comprised of an internal support structure 31 and an external support structure 34. In addition to performing other functions, the seal support means (internal support structure 31 and the external support structure 34 in this embodiment) allow a portion of the duct sealing means (internal seal member 32 and the external seal member 33) to change shape to conform to the shape of the exterior surface at the end of the duct (pipe 70), while also providing structural support to hold the duct (pipe 70) and the duct sealing means (internal seal member 32 and the external seal member 33) in place relative to one another and the casing member 20, all as described in more detail below. In the illustrated embodiment, as best illustrated in FIG. 2 and FIG. 4, the internal support structure 31 is comprised of an internal support flange member 31a and a plurality of internal support tab members 31b that extend from the interior perimeter of the internal support flange member 31a into the vicinity of the interior surface 32c of the internal seal member 32. At least a portion of the internal support structure 31 is positioned in the vicinity of the internal seal member 32. The internal support flange member 31a is preferably positioned approximately adjacent to the internal seal flange portion 32a of the internal seal member 32. By “approximately adjacent,” it is meant that the internal support flange member 31a is generally intended to be positioned adjacent to the internal seal flange portion 32a, but that other items, such as washers, o-rings or other members, may be positioned between the internal support flange member 31a and the internal seal flange portion 32a in some embodiments. The internal support flange member 31a is also preferably attached (but need not be attached in every embodiment) to the internal seal flange portion 32a using any suitable means, such as adhesive, adhesive tape, glue or epoxy, welding, fusing, clasps, clamps, or other suitable attachment means or a combination of such means. The internal support flange member 31a may have a different size and shape in other embodiments of the present invention. For example, where the case base 21 has a hexagonal cross-section, it may be necessary or desirable for the internal support flange member 31a to be hexagonal as well to facilitate the connection of the modular connector 33 to the casing member 20. In other embodiments, there may be more or fewer internal support tab members 31b, or the internal support tab members 31b may have a different shape than that illustrated in FIG. 2 and FIG. 4, or both. The internal support structure 31 may be comprised of any suitable rigid or semi-rigid material, such as metal (such as steel, steel alloys, aluminum, copper, brass, or other metals or metal alloys), polymers (such as PVC, polyethylene, polypropylene, ABS, NYLON and NYLON/glass combinations, and other polymers), wood, fiberglass, carbon-based or other composites, or other materials or a combination of such materials. Although the internal support flange member 31a and the internal support tab members 31b are preferably comprised of the same material, they may be comprised of different materials in various embodiments. The internal support structure 31 may be fabricated using any suitable means, such as injection molding for an internal support structure 31 comprised of polymers and metal injection molding for an internal support structure 31 comprised of metal. More preferably, the internal support structure 31 has the geometry illustrated in FIG. 2 and FIG. 4, and is comprised of stainless steel or a NYLON/glass combination, which may be fabricated using metal injection molding or injection molding, respectively. It is to be noted that there may be more than one internal support structure 31 utilized in some embodiments of the present invention.

As is best illustrated in FIG. 2, FIG. 4, FIG. 7A through FIG. 7C, and FIG. 9B, the external support structure 34 is comprised of an external support flange member 34a, an external support shell member 34b, a plurality of seal support members 34c, a plurality of radial support members 34d, and a plurality of end support members 34e. The seal support members 34c, the radial support members 34d, and the end support members 34e are sometimes referred to collectively as “external supporting members” herein. The external supporting members 34c, 34d, 34e extend from the interior surface of the external support shell member 34b into the interior space of the external support shell member 34b, which may also be in the vicinity of the external seal member 33. Among other things, the external support structure 34 (as a part of the seal support means) serves to guide the duct sealing means (internal seal member 32 and the external seal member 33) into their desired positions while the duct (pipe 70) is being inserted into the device 15. In addition, the external support structure 34 (as a part of the seal support means) allows a portion of the internal seal member 32 and a portion of the external seal member 33 (together as duct sealing means) to change shape to conform to the shape of the exterior surface of the duct (pipe 70) at the end thereof, while also providing structural support to hold the duct (pipe 70), the duct sealing means (internal seal member 32 and external seal member 33), and the seal support means (internal support structure 31 and external support structure 34) in place relative to one another and the casing member 20, all as described in more detail below. The features, functions and operation of the external support structure 34 are described in more detail below.

In the illustrated embodiment, the external support flange member 34a is an annular-shaped rigid member that is rigidly connected to the casing member 20, being positioned between the washer 35 and the external seal flange portion 33a. Preferably, the external support flange member 34a is attached to the washer 35 and the external seal flange portion 33a using any suitable means, such as an adhesive, adhesive tape, glue, epoxy, welding, fusing, clamp, clasp or other fastening means or a combination of such means. The external support flange member 34a may have a different size and shape in other embodiments of the present invention. For example, where the case base 21 has a hexagonal cross-section, it may be necessary or desirable for the external support flange member 34a to be hexagonal to facilitate its connection to the case base 21. In the illustrated embodiment, the external support shell member 34b extends from the interior edge of the external support flange member 34a a distance adequate to operationally enclose the internal seal member 32 and the external seal member 33. Preferably, the external support shell member 34b is positioned approximately adjacent to the interior surface of the case base 21 along its entire length, but it need not be so positioned in every embodiment of the present invention. Although the illustrated external support shell member 34b is tubular in shape, it may have a different shape in other embodiments. For example, where the case base 21 has a hexagonal cross-section, it may be necessary or desirable for the external support shell member 34b to be hexagonal to facilitate its operation in conjunction with the case base 21, as such operation is generally illustrated and described below in connection with FIG. 9B. The external support shell member 34b may also have one or more shell slits 34f that extend from the distal end of the external support shell member 34b approximately longitudinally a predetermined distance toward the external support flange member 34a. The shell slits 34f permit the external support shell member 34b to be deflected radially outward in order to be able to remove the duct (pipe 70) from the device 15 when it is desirable to do so. In other embodiments, there may be more or fewer shell slits 34f or no shell slits 34f at all or the shell slits 34f may have a different shape.

In the embodiment of the device 15 illustrated in FIG. 2 and FIG. 7A through FIG. 7C, the plurality of seal support members 34c extend from the interior surface of the external support shell member 34b into the interior space within the external support shell member 34b. Preferably, the seal support members 34c conform approximately to a portion of the contour of the exterior surface 33d of the external seal sheath portion 33b and generally extend along the exterior surface 33d of the external seal sheath portion 33b to the distal end thereof. The seal support members 34c are preferably constructed of a resilient material that may be deformed radially outward from the longitudinal center of the external support shell member 34b while the duct (pipe 70) is inserted into the device 15, but which apply a force radially inward against the external seal sheath portion 33b and the internal seal sheath portion 33b, so that the duct (pipe 70) tends to be held operatively in place radially with respect to the external support shell member 34b. In addition, as portions of the internal seal sheath portion 32b and the external seal sheath portion 33b slide along one another circumferentially as a duct (pipe 70) of larger size is inserted into the device 15, the seal support members 34c also tend to hold the internal seal sheath portion 32b and the external seal sheath portion 33b in place relative to one another so that they are not unduly deflected radially outward. In other embodiments, there may be fewer or more seal support members 34c, or the seal support members 34c may have a shape and size different from that illustrated in FIG. 2 and FIG. 7A through FIG. 7C, or both.

In the embodiment of the device 15 illustrated in FIG. 2 and FIG. 7A through FIG. 7C, each of the plurality of radial support members 34d extends from the interior surface of the external support shell member 34b into the interior space within the external support shell member 34b. Preferably, the radial support members 34d generally extend into the interior space of the external support shell member 34b a distance great enough so that they will abut against the exterior surface of the smallest size of duct (pipe 70) that may be connected to the device 15 when the duct (pipe 70) is inserted into the device 15. In other embodiments, there may be fewer or more radial support members 34d, or the radial support members 34d may have a configuration, shape and size different from that illustrated in FIG. 2 and FIG. 7A through FIG. 7C, or both. As best illustrated in FIG. 7A through FIG. 7C and FIG. 9B with respect to the variable connecting member 40, the distal end of each of the radial support members 44d may also preferably have a slightly arcuate shape so that the distal end may engage any threads 75a present on the end of the duct (pipe 75), which may provide additional assistance in operatively holding the duct (pipe 75) in place relative to the device 15 against any thrust loads.

In the embodiment of the device 15 illustrated in FIG. 2 and FIG. 7A through FIG. 7C, the plurality of duct end support members 34e extend from the interior surface of the external support shell member 34b into the interior space within the external support shell member 34b. The duct end support members 34e extend into the interior space of the case body 21 a distance great enough so that they will abut against the end of the smallest size of duct (pipe 70) that may be connected to the device 15 when the duct (pipe 70) is inserted into the device 15. In addition, the duct end support members 34e are preferably shaped to minimize the disruption of fluid flowing from the duct (pipe 70) through the casing member 20. Thus, the duct end support members 34e act as a stop, preventing the duct (pipe 70) from being inserted into the casing member 20 beyond the duct end support members 34e, while still allowing for relatively unrestricted fluid flow through the device 15. In other embodiments, there may be fewer or more duct end support members 34e, or the duct end support members 34e may have a configuration, shape and size different from that illustrated in FIG. 2 and FIG. 7A through FIG. 7C, or both.

The external support flange member 34a, the external support shell member 34b, and the external supporting members 34c, 34d, 34e may each be constructed of any suitable material, as long as they are capable of performing their functions of allowing a portion of the internal seal member 32 and a portion of the external seal member 33 (together as duct sealing means) to change shape to conform to the shape of the exterior surface of the duct (pipe 70) at the end thereof, while also providing structural support to hold the duct (pipe 70), the duct sealing means (internal seal member 32 and external seal member 33), and the seal support means (internal support structure 31 and external support structure 34) in place relative to one another and the casing member 20, all as described in more detail below. Preferably, the external support flange member 34a, the external support shell member 34b, and the external supporting members 34c, 34d, 34e are comprised of a rigid or semi-rigid material, such as metal (e.g., spring steel, copper, brass, aluminum, another steel, or steel or metal alloy), wood, ceramic, fiberglass, carbon-based or other composites, rigid or semi-rigid polymers (such as PVC, NYLON or NYLON/glass combination, and polycarbonate), or other rigid or semi-rigid materials or a combination of such materials. In addition, it is preferred that the material comprising the external support flange member 34a, the external support shell member 34b, and the external supporting members 34c, 34d, 34e be compatible with the fluid carried by the duct (pipe 70). The external support flange member 34a, the external support shell member 34b, and the external supporting members 34c, 34d, 34e are preferably fabricated of the same material as a single component. Alternatively, the external support flange member 34a, the external support shell member 34b, and the external supporting members 34c, 34d, 34e may each be constructed of different materials or a combination of materials or may be connected to one another by a suitable joining means, such as an adhesive, adhesive tape, glue, epoxy, welding, fusing, brazing, or other joining means or a combination of such means, or both.

Although the illustrated embodiment is the preferred embodiment, it is to be noted that there are numerous potential variations in the structure, features, characteristics and operation of the seal support means. While the seal support means (internal support structure 31 and external support structure 34 in the illustrated embodiments) are described in conjunction with the preferred aspects, versions and embodiments, it is to be noted that the aspects, versions and embodiments are not intended to limit the invention to those aspects, versions and embodiments. On the contrary, the seal support means are specifically intended to cover alternatives, modifications and equivalents, which may be included within the spirit and scope of the invention as defined by the appended claims. For example, the seal support means of the present invention may include any internal support means or support assembly or both disclosed in U.S. patent application Ser. No. 11/879,346 filed on Jul. 17, 2007, and any seal support means disclosed in U.S. patent application Ser. No. 12/012,954 entitled DUCT COUPLING ADJUSTMENT AND THRUST LOAD RESTRAINT SYSTEM, filed on Feb. 6, 2008, and U.S. Provisional Patent Application No. 61/062,428 filed on Jan. 25, 2008. The full disclosure of each of these patent applications is incorporated herein by this reference.

In the illustrated embodiment, as best illustrated in FIG. 1C, FIG. 2, and FIG. 9B, the external support flange member 34a is positioned between a washer 35 and a portion of the surface of the external seal flange portion 33a of the external seal member 33. In this embodiment, the washer 35 (which comprises a part of the variable member connecting means and the modular connecting means) is positioned between the external support flange member 34a of the external support structure 34 and the open end 21a of the case body 21. In the illustrated embodiment, as the case cap 22 is screwed down onto the case body 21, the portion of the case cap 22 adjacent to the connector opening 22a is pressed against the internal support flange member 31a of the internal support member 31, the internal seal flange portion 32a of the internal seal member 32, the external seal flange portion 33a of the external seal member 33, the external support flange member 34a of the external support structure 34, and the washer 35. This compression, acting as variable member connecting means (and also modular connecting means) to connect the variable connecting member 30 to the casing member 20, also provides a fluid-tight seal between the variable connecting member 30 and the casing member 20, so that a fluid-tight chamber 60 is formed. In the illustrated embodiment, the chamber 60 is bounded by the exterior surfaces 32d, 33d of the internal seal member 32 and the external seal member 33, respectively, the equivalent surfaces of the variable connecting member 40, the internal surfaces of the case body 21, and the internal surfaces of the duct (pipes 70, 75). In other embodiments, which are the preferred embodiments, two or more of the components comprising the variable connecting member 30 may also be joined together using any suitable means. For example, portions of the internal seal member 32 and portions of the external seal member 33 may be connected by seal connecting means, which are described in more detail above. In addition, the internal support flange member 31, the internal seal flange portion 32a, the external seal flange portion 33a, the external support flange member 34a, and the washer 35 may each be attached to the adjoining member by an adhesive, adhesive tape, glue or epoxy or a combination of the same. Other possible means of attachment may include welding, fusing, clasps, clamps, or other suitable attachment means or a combination of such means.

A method of operating the device 15 to connect the variable connecting members 30, 40 to ducts of various sizes and shapes is best illustrated in FIG. 9B. FIG. 9B illustrates the variable connecting member 30 as it is connected to a duct (pipe 70) of relatively larger diameter that does not have threads on its distal end. FIG. 9B also illustrates the variable connecting member 40 as it is connected to a duct (pipe 75) of relatively smaller diameter having threads 75a on its distal end. It is to be noted that the operation of the variable connecting member 40 has substantially the same structure, features, characteristics, functions and operation as the variable connecting member 30 illustrated and described in more detail herein. As illustrated in FIG. 3, FIG. 8A, and FIG. 9B, variable connecting member 40 is, however, further comprised of a variable connector adapter member 46 and a washer 47. The variable connector adjusting member 46 is further comprised of a variable adapter flange portion 46a and a variable adapter shell portion 46b. The washer 47 is positioned between the variable adapter flange portion 46a and the external support flange member 44a, with the washer assisting in forming a fluid-tight seal between the external support structure 44 and the variable connector adapter member 46. The external support structure 44, the washer 47, the variable connector adapter member 46, or any combination thereof may also be connected together using an adhesive, adhesive tape, welding, fusing, clamps or other fastening means or a combination of such means. The variable connector adapter member 46 is adapted to be of a size and shape so that the variable connecting member 40 may be connected to the casing member 20 using the appropriate modular connecting means, as described in more detail above and illustrated in connection with FIG. 1A through FIG. 9B. The variable connector adapter member 46 may generally be constructed of any materials that may comprise the casing member 20, and may also be fabricated using any means to fabricate the casing member 20. For example, a variable connector adapter member 46 comprised of PVC may be fabricated by injection molding. In other embodiments, the variable connector adapter member 46 may have a different size and shape, as long as the variable connector adapter member 46 is capable of performing its function of assisting the connection of a relatively smaller size of variable connecting means 40 to the casing member 20 and acting as a part of the modular connecting means in doing so. For example, as illustrated in FIG. 8B, the variable connector adapter member 46′ may have one or more slits 46c′ positioned in the variable adapter shell portion 46b′, or as illustrated in FIG. 8D, the variable connector adapter member 146 may have a variable adapter shell portion 46b′ that is approximately hexagonal in shape. In the case of operation of the variable connecting member 40, the duct (pipe 75) is inserted through the connector opening 23a into the variable connecting member 40.

The operation of the device 15 as part of a system in which the fluid is under pressure is as follows, but it is to be noted that the device 15 need not be operated as part of a system where the fluid is under pressure. First, the device 15 is selected and the threaded 75a end of the duct (pipe 75) is inserted into (and received by) the connector opening 23a of the casing member 20, the internal support structure 41, and the internal seal inlet 42e of the variable connecting member 40. In this embodiment, the duct (pipe 75) has a generally cylindrical shape and an outside diameter within a predetermined range. For example, the pipe 75 in some embodiments may have an outside diameter within the range of 0.8 inches to 1.0 inches. In addition, the duct (pipe 75) may have a variety of different thread 75a types on its end, as described in more detail above. Thus, the device 15 is capable of connecting to a variety of different types and sizes of ducts (pipe 75). As illustrated in FIG. 9B, as the duct (pipe 75) is being inserted into (and received by) the device 15, if the outside diameter of the duct (pipe 75) is the minimum acceptable diameter of the duct (pipes 75) the distal end of the duct (pipe 75) may travel down the longitudinal axis of the variable connecting member 40 with only minimal contact against the internal support tab members 41b and the internal seal member 42. The duct (pipe 75) is advanced into the device 15 until a portion of the interior surface 42c of the internal seal member 42 and a portion of the interior surface 43c of the external seal member 43 have changed shape, and possibly expanded, to conform to and be positioned adjacent to the exterior surface of the duct (pipe 75). As the duct (pipe 75) is inserted into the internal seal member 42 and the external seal member 43, the exterior surface 42d of the internal seal sheath portion 42b may slide circumferentially along the interior surface 43c of the external seal sheath portion 43b, causing the internal seal slit 42g and the external seal slit 43g to widen. In the case of smaller duct (pipe 75) sizes, the pipe 75 is operatively held in place in the device 15 primarily by the inward radial pressure of the inlet support tab members 41b, the seal support members 44c, and the radial support members 44d, and secondarily by the internal seal member 42 and the external seal member 43. In other embodiments, all or any combination of the duct sealing means or the seal support means (which are described in more detail above and illustrated in connection with FIG. 2 through FIG. 9B) may be used to hold the pipe 75 operatively in place in the device 15. In embodiments of the device 15 that comprise duct end support members 44e, the duct (pipe 75) may be inserted into the device 15 until the duct (pipe 75) open end abuts against the duct end support members 44e.

Continuing to refer to FIG. 9B, in cases where the duct (pipe 70) has a relatively large diameter, as the duct (pipe 70) is inserted into the device 15, the duct (pipe 70) first impacts the internal support tab members 31b of the internal support structure 31, causing the internal support tab members 31b to be deformed radially against the interior surface 32c of the internal seal member 32 and the interior surface 33c of the external seal member 33. As the duct (pipe 70) continues into the device 15, the distal end of the duct (pipe 70) continues to force the internal support tab members 31b radially outward against the internal seal member 32 and the external seal member 33, forcing them to expand radially outward. As this happens, the exterior surface 32d of the internal seal sheath portion 32b slides circumferentially along the interior surface 33c of the external seal sheath portion 33b, causing the internal seal slit 32g and the external seal slit 33g to widen. This deformation also causes the exterior surface 32d of the internal seal member 32 and the exterior surface 33d of the external seal member 33 to be forced against the seal support members 34c, which causes the seal support members 34c to deform radially outward as well. As the internal seal member 32 and the external seal member 33 are forced against the seal support members 34c, the seal support members 34c tend to hold the internal seal member 32 and the external seal member 33 in place relative to one another so that the portions 32b′, 33b′ adjacent to the internal seal slit 32g and the external seal slit 33g, respectively, are not deflected radially outward a detrimental amount. In addition, the internal support tab members 31b and the seal support members 34c hold the duct (pipe 70) radially centered in the device 15 as the pipe 70 continues its travel into the device 15. The internal support tab members 31b also prevent the duct (pipe 70) from binding or impinging against the interior surface 32c of the internal seal member 32 and the interior surface 33c of the external seal member 33 as the duct (pipe 70) is being inserted into the device 15.

As the duct (pipe 70) is advanced further into the device 15, the duct (pipe 70) continues forcing the internal seal member 32 and the external seal member 33 to expand radially outward until a portion of the interior surface 32c of the internal seal member 32 and the interior surface 33c of the external seal member 33 have expanded to conform to and are positioned adjacent to the exterior surface of the duct (pipe 70). As the duct (pipe 70) is advanced into the device 15 beyond the internal seal outlet 32f and the external seal outlet 33f, the end of the duct (pipe 70) is forced against the radial support members 34d. As the duct (pipe 70) is advanced even further, the duct (pipe 70) causes the radial support members 34d to deform radially outward and longitudinally as well, so that the radial support members 34d also hold the duct (pipe 70) radially centered in the device 15 as the pipe 70 continues its travel into the device 15. The pressure exerted by the internal support tab members 31b, the seal support members 34c, and the radial support members 34d may also operatively hold the internal seal member 32 and the external seal member 33 and the duct (pipe 70) operatively in place relative to one another and the casing member 20. As illustrated in FIG. 9B with respect to variable connecting member 40, the longitudinal displacement of the radial support members 44d also preferably causes them to engage the threads 75a on the duct (pipe 75) in cases where threads 75a are present, acting as an even greater restraining force to operatively hold the duct (pipe 75) in place. Referring again to the variable connecting member 30 of FIG. 9B as an example, in other embodiments, all or any combination of the internal support structure 31 or the external support structure 34 or both (which are described in more detail above and illustrated in connection with FIG. 2 through FIG. 7C) may be used to hold the pipe 70 operatively in place in the device 15. In embodiments of the device 15 that comprise duct end support members 34e, the duct (pipe 70) may be inserted into the device 15 until the distal end of the duct (pipe 70) abuts against the duct end support members 34e. In embodiments of the present invention that further comprise object connecting means (as described in more detail above and illustrated in connection with FIG. 14A and FIG. 14B), the method of using the device 15 may be comprised of selecting the device 15, and in any order: (a) connecting the duct (pipe 70) to the device 15 (in this embodiment, by inserting the duct (pipe 70) into the casing connector opening 22a and advancing the duct (pipe 70) into the device 15 until a portion of the interior surface 32c of the internal seal member 32 and the interior surface 33c of the external seal member 33 have changed shape to conform to and are positioned adjacent to the exterior surface of the duct (pipe 70); and (b) connecting the object (not illustrated) to the device 15 utilizing the object connecting means (not illustrated). When the device 15 is no longer needed for connecting to the duct (pipe 70), the variable connecting member 30 may be removed from the casing member 20, the portions of the external support shell member 34b may be pulled radially outward, releasing the radially inward pressure of the seal support members 34c and the radial support members 34d against the duct (pipe 70), and the duct (pipe 70) may then be removed from the variable connecting member 30.

In some cases, such as cases where the device 15 is operating at relatively high pressures (i.e., higher pressures in the chamber 60) or where only minimal contact may be present between the internal seal member 32 and the external seal member 33, on the one hand, and the exterior surface of the duct (pipe 70), on the other hand, because of minimum duct (pipe 70) size, supplemental duct sealing means may be utilized to provide or enhance the seal between the internal seal member 32 and the external seal member 33 and the duct (pipe 70). Examples of such means include adhesive, glue, epoxy or other joining compound or a combination of such means that is stored in a container or other receptacle, which is then positioned as a film 90 on a portion of the duct sealing means (32, 33) or the duct (pipe 70) or both prior to connecting the duct (pipe 70) to the device 15. The adhesive film 90 may provide for a relatively permanent attachment of the internal seal member 32 and the external seal member 33 to the duct (pipe 70), so that the internal seal member 32 and the external seal member 33 are not easily removed from the duct (pipe 70). An example of this type of adhesive is Cyanoacrylate (methyl-2-cyanoacrylate), which may be typically sold under the trademark SUPERGLUE. Alternatively, the adhesive film 90 may provide for non-permanent attachment of the internal seal member 32 and the external seal member 33 to the duct (pipe 70), so that the internal seal member 32 and the external seal member 33 are relatively easily removed from the duct (pipe 70) after use of the device 15 is completed. An example is an adhesive similar to rubber cement made from a polymer (such as latex) mixed in a solvent such as acetone, hexane, heptane or benzene to keep the polymer fluid prior to use. In addition, the adhesive film 90 may be comprised of an adhesive layer 90 with a peel-off strip (not illustrated) positioned over the adhesive layer 90, which is removed prior to insertion of the duct (pipe 70) into the device 15. For example, this type of adhesive layer 90 and peel-off strip may be comprised of double coated urethane, vinyl or polyethylene adhesive tapes with release liners, such as those manufactured by the 3M Company. The supplemental duct sealing means of the present invention may include any of the supplemental duct sealing means disclosed in U.S. patent application Ser. No. 11/879,346 filed on Jul. 17, 2007, Ser. No. 12/012,954 entitled DUCT COUPLING ADJUSTMENT AND THRUST LOAD RESTRAINT SYSTEM, filed on Feb. 6, 2008, and U.S. Provisional Patent Application No. 61/062,428 filed on Jan. 25, 2008. The full disclosure of each of these patent applications is incorporated herein by this reference.

Thus, referring to the embodiment of the device 20 illustrated in FIG. 1A through FIG. 9B as an example, as is apparent from the foregoing description, the preferred type and structure of internal support structure 31, internal seal member 32, external seal member 33, external support structure 34, and variable connecting member support means, as well as other structural characteristics of the device 15, are dependent upon numerous different factors. In addition, the preferred types and structure of the casing members 20, the modular connectors 30, 40, and the modular connecting means (which are described in more detail above), are also dependent upon numerous different factors. A device 15 having a particular combination of features appropriate for one type of operating condition may not be appropriate for other types of operating conditions. In addition to the preferences described above, in the case of a device 15 designed for use with room temperature domestic potable water and capable of accommodating pipes 70, 75 in the range of ¾″ to ½″ nominal diameter, the type of casing member 20 described above and illustrated in connection with FIG. 1A through FIG. 1C and FIG. 9B is preferred, and the preferred modular connecting means is that which is a part of the modular connectors 454, 555 illustrated in FIG. 13A through FIG. 13C and FIG. 14A and FIG. 14B.

The present invention also includes kits (not directly illustrated) that comprise various combinations of components of the present invention, such components being described in more detail elsewhere herein. For example, a kit may comprise two or more modular connectors 30, 40, 240, 250, 251, 352, 353, 454, 555, 656, 785, 786, 857, 858, 959, 1050, 1051 comprising any combination or combinations of any embodiments of such modular connectors, as described in more detail above and illustrated in connection with FIG. 1A through FIG. 18C. In addition, a kit may comprise two or more casing members 20, 120, 220, 320, 420, 520, 620, 720, 720, 820, 820, 920, 1020 in any combination or combinations of any embodiments of such casing members, or in any combination or combinations of any embodiments of any component parts (such as case caps) comprising such casing members, as described in more detail above and illustrated in connection with FIG. 1A through FIG. 18C. Further, a kit may comprise one or more modular connectors 30, 40, 240, 250, 251, 352, 353, 454, 555, 656, 785, 786, 857, 858, 959, 1050, 1051 comprising any combination or combinations of any embodiments of such modular connectors, and one or more casing members 20, 120, 220, 320, 420, 520, 620, 720, 720, 820, 820, 920, 1020 in any combination or combinations of any embodiments of such casing members, or in any combination or combinations of any embodiments of any component parts (such as case caps) comprising such casing members, all as described in more detail above and illustrated in connection with FIG. 1A through FIG. 18C. Referring to the device 15 illustrated in FIG. 1A through FIG. 9B as an example, a method of using the device 15 is also disclosed, the method comprising selecting the casing member 20 and connecting a modular connector (variable connecting member 30) to the casing member 20 using the modular connecting means, which is described in more detail above. In embodiments comprising a case body 21 and a case cap 22, the method may comprise positioning the modular connector (variable connecting member 30) adjacent to the case body 21 using the modular connecting means, and then positioning the case cap 22 on the case body 21 using the case cap connecting means.

What is claimed is:

1. A device for connecting to at least one duct, the device comprising:
(a) a casing member further comprised of modular connecting means adapted for connecting the casing member to at least one first modular connector; and
(b) at least one first modular connector comprising:
(i) modular connecting means for connecting the at least one first modular connector to the casing member; and
(ii) duct connecting means for connecting the at least one first modular connector to at least one duct;
(c) wherein the modular connecting means of the casing member are also adapted for connecting to at least one second modular connector that comprises modular connecting means, so that the at least one first modular connector is interchangeable with the at least one second modular connector in operation with the casing member.

2. The device of claim 1, wherein:
(a) the casing member is comprised of:
(i) a case body having a casing interior space and comprising at least one case body open end adjoining the casing interior space;
(ii) a case cap having a connector opening; and
(iii) case cap connecting means for removably or permanently connecting the case cap to the case body at the at least one case body opening;
(b) wherein the duct connecting means are adapted to be positioned approximately within the connector opening, and the at least one first modular connector and the at least one second modular connector are adapted to be separately positioned approximately within the case body open end, while the case cap is connected to the case body.

3. The device of claim 2, wherein the case cap connecting means are comprised of a threaded portion on the case body adjacent to the at least one case body open end and a threaded portion on an opening of the case cap, so that the case cap is adapted to be screwed down onto the case body.

4. The device of claim 2, wherein:
(a) the at least one first modular connector is further comprised of a connector flange portion and a connector shell portion extending from the connector flange portion; and
(b) the connector flange portion is positioned within the connector opening, and the connector shell portion extends in the direction of the casing interior space.

5. The device of claim 1, wherein the duct connecting means are comprised of a variable connecting member adapted to be connected to the at least one duct, wherein the at least one duct comprises a duct open end and a duct exterior surface adjacent to the duct open end having a size and shape within a predetermined range adapted to be connected to the variable connecting member.

6. A device comprising:
(a) a casing member having a casing interior space and comprising:
(i) at least one casing open end adjoining the casing interior space; and
(ii) modular connecting means adapted for connecting a modular connector to the casing member at the at least one casing open end;
(b) wherein:
(i) the modular connector is comprised of:
(A) modular connecting means for connecting the modular connector to the casing member at the at least one casing opening; and
(B) duct connecting means for connecting the modular connector to at least one duct; and
(ii) the casing member is adapted to be connected to at least one additional modular connector comprising additional modular connecting means that are operatively the same as the modular connecting means comprising the modular connector, so that the modular connector is interchangeable with the at least one additional modular connector in operation with the casing member.

7. The device of claim 6, wherein:
(a) the casing member is comprised of a case cap having a connector opening, a case body comprising at least one case body open end adjoining the casing interior space, and case cap connecting means for removably or permanently connecting the case cap to the case body at the at least one case body open end; and
(b) the at least one casing open end is comprised of the connector opening and the at least one case body open end, the modular connector and the at least one additional modular connector are adapted to be separately positioned approximately within the case body open end while the case cap is positioned on the case body, and the modular connector is adapted to be connected to the at least one duct through the connector opening.

8. The device of claim 6, wherein the casing member further comprises object connecting means adapted for connecting an object to the casing member.

9. The device of claim 8, further comprising the object.

10. The device of claim 6, wherein the duct connecting means are further comprised of variable connecting means adapted for connecting the modular connector to the at least one duct, wherein the at least one duct comprises a duct open end and a duct exterior surface adjacent to the duct open end having a size and shape within a predetermined range adapted to be connected to the variable connecting means of the modular connector.

11. The device of claim 6, wherein the duct connecting means is comprised of second modular connecting means for connecting the modular connector to a second modular connector.

12. A device comprising:
(a) a modular connector adapted to be permanently or removably connected to a casing member and further comprising duct connecting means adapted for connecting the modular connector to at least one duct;
(b) wherein the casing member comprises an interior space and at least one casing open end adjoining the casing interior space, and the at least one casing open end is adapted to be permanently or removably connected to the modular connector and at least one additional modular connector, so that the modular connector is interchangeable with the at least one additional modular connector as part of a modular coupling system.

13. The device of claim 12, wherein:
(a) the modular connector is further comprised of at least one connector flange portion and at least one connector shell portion extending from the at least one connector flange portion; and
(b) the at least one connector flange portion is positioned approximately adjacent to the at least one casing open end and the at least one connector shell portion extends in the direction of the casing interior space.

14. The device of claim 13, wherein a washer, gasket or o-ring is adapted to be positioned between the at least one connector flange portion and the at least one casing open end.

15. The device of claim 13, wherein an adhesive, adhesive tape, glue, or epoxy is adapted to be positioned between the at least one connector flange portion and the at least one casing open end.

16. The device of claim 13, wherein:
(a) the duct connecting means are comprised of an additional connector flange portion and an additional connector shell portion extending from the additional connector flange portion; and
(b) the additional connector flange portion and the additional connector shell portion are adapted to operatively connect the modular connector to an additional casing member.

17. A device for connecting to a duct, the device comprising:
(a) a modular connector adapted to be connected to a casing member and further comprising a variable connecting member for connecting the modular connector to a duct, wherein the duct comprises a duct open end and a duct exterior surface adjacent to the duct open end having a size and shape within a predetermined range adapted to be connected to the variable connecting member of the modular connector;
(b) wherein the casing member has an interior space and is comprised of at least one casing opening adjoining the interior space, wherein the at least one casing opening is adapted to be permanently or removably connected to the modular connector and at least one additional modular connector, so that the modular connector is interchangeable with the at least one additional modular connector as part of a modularized system of interchangeable modular connectors.

18. The device of claim 17, further comprising the casing member.

19. The device of claim 17, wherein the modular connector further comprises:
(a) a variable connector adapter member positioned between the variable connecting member and the casing member; and
(b) adapter connecting means for operatively connecting the variable connecting member to the variable connector adapter member.

20. The device of claim 17, wherein the variable connecting member comprises:
(a) a hollow internal seal member having an internal seal inlet and an internal seal outlet;
(b) a hollow external seal member having an external seal inlet and an external seal outlet, wherein at least a portion of the internal seal member is positioned within the external seal member;
(c) seal connecting means for connecting a portion of the internal seal member adjacent to the internal seal inlet to a portion of the external seal member adjacent to the external seal inlet;
(d) an internal support structure, wherein at least a portion of the internal support structure is positioned in the vicinity of the internal seal member; and
(e) an external support structure, wherein at least a portion of the external support structure is positioned in the vicinity of the external seal member;
(f) wherein a portion of the internal seal member and a portion of the external seal member are adapted to change shape to conform to the shape of and be positioned adjacent to the duct exterior surface of the duct, and the internal support structure and the external support structure are adapted to assist in holding the internal seal member, the external seal member, the casing member, and the duct operatively in place relative to one.
